(19) United States
(12) Patent Application Publication
(10) Pub. No.: US 2026/0036838 A1
(43) Pub. Date: Feb. 5, 2026

(54) VIEWING ANGLE CONTROL SYSTEM AND IMAGE DISPLAY APPARATUS

(71) Applicant: FUJIFILM Corporation, Tokyo (JP)

(72) Inventors: Fumitake MITOBE, Minamiashigara-shi (JP); Shinichi YOSHINARI, Minamiashigara-shi (JP); Naoki KOITO, Minamiashigara-shi (JP)

(73) Assignee: FUJIFILM Corporation, Tokyo (JP)

(21) Appl. No.: 19/357,127

(22) Filed: Oct. 14, 2025

Related U.S. Application Data
(63) Continuation of application No. PCT/JP2024/017802, filed on May 14, 2024.

(30) Foreign Application Priority Data
May 23, 2023 (JP) 2023-084751

(51) Int. Cl. G02F 1/13; G02F 1/1335

(52) U.S. Cl. CPC G02F 1/1323; G02F 1/133528

(57) ABSTRACT

A viewing angle control system includes sequentially: a first polarizer, a first optical compensation layer, a first TN-mode liquid crystal cell, a second polarizer, a second TN-mode liquid crystal cell, a second optical compensation layer, and a third polarizer. The first and second optical compensation layers each exhibit minimum retardation in a tilted direction rather than in a normal direction. The system provides high brightness in a front direction and low brightness in an oblique direction at a specific azimuthal angle when applied to a light source.

### CROSS-REFERENCE TO RELATED APPLICATIONS

This application is a Continuation of PCT International Application No. PCT/JP2024/017802 filed on May 14, 2024, which claims priority under 35 U.S.C. § 119 (a) to Japanese Patent Application No. 2023-084751 filed on May 23, 2023. The above applications are hereby expressly incorporated by reference, in their entirety, into the present application.

### BACKGROUND OF THE INVENTION

### 1. Field of the Invention

The present invention relates to a viewing angle control system and an image display apparatus.

### 2. Description of the Related Art

An image display apparatus such as a liquid crystal display device or an organic electroluminescence (EL) display device is frequently used as a display for a car navigation system, a smartphone, a laptop computer, or the like. In this display, an image can be observed from an observer in a desired direction. However, for example, in a case where it is difficult to observe an image from the other directions, a control regarding a viewing angle direction may be required.

For example, as a display device that can control a viewing angle, JP2021-156943A discloses a display device including: a first viewing angle control panel that includes a first liquid crystal layer including twist-aligned liquid crystal molecules; and a second viewing angle control panel that includes a second liquid crystal layer including twist-aligned liquid crystal molecules.

### SUMMARY OF THE INVENTION

On the other hand, recently, from the viewpoint of controlling light emitted from a light source, it is desired to realize an optical system having a high brightness in the vicinity of a front direction of a light source and having a low brightness in a direction (oblique direction) tilted from the front direction. In particular, in the optical system having a low brightness in the oblique direction at a predetermined azimuthal angle, in a case where the optical system is disposed in front of a passenger seat of a vehicle, it is possible to realize a configuration where an image can be observed from the passenger seat but cannot be observed from a cab seat.

The present inventors investigated the characteristics of the image display apparatus described in JP2021-156943A, and found that achieving both of a high brightness in the front direction and a low brightness in the oblique direction was not sufficient and further improvement is required.

The present invention has been made in consideration of the above-described circumstances, and an object thereof is to provide a viewing angle control system where, during application to a light source, a high brightness in a front direction and a low brightness in an oblique direction at a specific azimuthal angle can be realized.

Another object of the present invention is to provide an image display apparatus.

The present inventors conducted thorough investigation on the above-described objects and found that the above-described objects can be achieved by the following configurations.

(1) A viewing angle control system comprising, in the following order:
a first polarizer;
a first optical compensation layer;
a first liquid crystal cell;
a second polarizer;
a second liquid crystal cell;
a second optical compensation layer; and
a third polarizer,
in which the first liquid crystal cell and the second liquid crystal cell are TN-mode liquid crystal cells,
the first optical compensation layer is a layer where, in a case where a retardation is measured from a normal direction of the first optical compensation layer and a direction tilted from the normal direction of the first optical compensation layer, the retardation is at a minimum in the direction tilted from the normal direction of the first optical compensation layer, and
the second optical compensation layer is a layer where, in a case where a retardation is measured from a normal direction of the second optical compensation layer and a direction tilted from the normal direction of the second optical compensation layer, the retardation is at a minimum in the direction tilted from the normal direction of the second optical compensation layer.

(2) The viewing angle control system according to (1),
in which the first optical compensation layer and the second optical compensation layer are layers obtained by immobilizing a tilt-aligned or hybrid-aligned liquid crystal compound.

(3) The viewing angle control system according to (2),
in which the liquid crystal compound is a disk-like liquid crystal compound or a rod-like liquid crystal compound.

(4) The viewing angle control system according to (2) or (3),
in which an angle between a projection axis where an optical axis of the liquid crystal compound in the first optical compensation layer is projected onto a surface of the first optical compensation layer and an in-plane slow axis on a surface of a liquid crystal layer in the first liquid crystal cell on the first optical compensation layer side is 45° to 135°, and
an angle between a projection axis where an optical axis of the liquid crystal compound in the second optical compensation layer is projected onto a surface of the second optical compensation layer and an in-plane slow axis on a surface of a liquid crystal layer in the second liquid crystal cell on the second optical compensation layer side is 45° to 135°.

(5) The viewing angle control system according to any one of (1) to (4), further comprising:
a third optical compensation layer that is provided between the first liquid crystal cell and the second polarizer; and
a fourth optical compensation layer that is provided between the second polarizer and the second liquid crystal cell,
the third optical compensation layer is a layer where, in a case where a retardation is measured from a normal direction of the third optical compensation layer and a direction tilted from the normal direction of the third optical compensation layer, the retardation is at a minimum in the direction tilted from the normal direction of the third optical compensation layer, and
the fourth optical compensation layer is a layer where, in a case where a retardation is measured from a normal direction of the fourth optical compensation layer and a direction tilted from the normal direction of the fourth optical compensation layer, the retardation is at a minimum in the direction tilted from the normal direction of the fourth optical compensation layer.

(6) An image display apparatus comprising:
an image display element; and
the viewing angle control system according to any one of (1) to (5).

According to the present invention, it is possible to provide a viewing angle control system where, during application to a light source, a high brightness in a front direction and a low brightness in an oblique direction at a specific azimuthal angle can be realized.

According to the present invention, it is possible to provide an image display apparatus.

### BRIEF DESCRIPTION OF THE DRAWINGS

FIG. 1 is a schematic cross sectional view showing a first embodiment of a viewing angle control system according to the present invention.

FIG. 2 is a diagram showing a relationship between a transmission axis of a first polarizer, a transmission axis of a second polarizer, and a transmission axis of a third polarizer in the viewing angle control system shown in FIG. 1 in observation from a white arrow direction of FIG. 1.

FIG. 3 is a diagram showing a relationship between the transmission axis of the first polarizer, a rod-like liquid crystal compound in a liquid crystal layer of a first liquid crystal cell, and the transmission axis of the second polarizer in the viewing angle control system shown in FIG. 1 in the observation from the white arrow direction of FIG. 1.

FIG. 4 is a diagram showing a relationship between the transmission axis of the second polarizer, a rod-like liquid crystal compound in a liquid crystal layer of a second liquid crystal cell, and the transmission axis of the third polarizer in the viewing angle control system shown in FIG. 1 in the observation from the white arrow direction of FIG. 1.

FIG. 5 is a diagram showing an alignment state of the rod-like liquid crystal compound in the liquid crystal layer of the second liquid crystal cell.

FIG. 6 is a diagram showing an alignment state of the rod-like liquid crystal compound in the liquid crystal layer of the second liquid crystal cell.

FIG. 7 is a diagram showing a result of visually recognizing light while changing an azimuthal angle and a polar angle from a white arrow direction shown in FIG. 6.

FIG. 8 is a diagram showing an alignment state of the rod-like liquid crystal compound in the liquid crystal layer of the first liquid crystal cell.

FIG. 9 is a diagram showing a result of visually recognizing light while changing an azimuthal angle and a polar angle from a white arrow direction shown in FIG. 8.

FIG. 10 is a diagram showing a range where ranges surrounded by thick lines in FIGS. 7 and 9 overlap each other.

FIG. 11 is a diagram showing configurations of the second liquid crystal cell and a second optical compensation layer.

FIG. 12 is a diagram showing a relationship between a projection axis where an optical axis of a disk-like liquid crystal compound is projected onto a surface of the second optical compensation layer and an in-plane slow axis on a surface of the liquid crystal layer in the second liquid crystal cell on the second optical compensation layer side.

FIG. 13 is a schematic cross sectional view showing a configuration of a second optical compensation layer in a modification example of the first embodiment of the viewing angle control system according to the present invention.

FIG. 14 is a diagram showing a relationship between a projection axis where an optical axis of a disk-like liquid crystal compound is projected onto a surface of the second optical compensation layer and an in-plane slow axis on a surface of a liquid crystal layer in the second liquid crystal cell on the second optical compensation layer side.

FIG. 15 is a schematic cross sectional view showing a second embodiment of the viewing angle control system according to the present invention.

### DESCRIPTION OF THE PREFERRED EMBODIMENTS

Hereinafter, the present invention will be described in detail.

The description of configuration requirements below may be made based on typical embodiments or specific examples, but the present invention is not limited to such embodiments.

In the present specification, numerical ranges represented by “to” include numerical values before and after “to” as lower limit values and upper limit values.

In addition, in the present specification, parallel and orthogonal do not denote parallel and orthogonal in a strict sense, respectively, but rather denote a range of parallel=5° (range of ±5° with respect to the parallel direction) and a range of orthogonal ±5° (range of ±5° with respect to the orthogonal direction), respectively.

In the present specification, “absorption axis” denotes a polarization direction in which an absorbance is the maximum in a plane in a case where linearly polarized light is incident. In addition, “transmission axis” denotes a direction having an angle of 90° with respect to the absorption axis in a plane. Furthermore, “in-plane slow axis” denotes a direction in which a refractive index is the maximum in a plane.

In addition, in the present specification, Re(λ) and Rth(λ) represent an in-plane-direction retardation and a thickness-direction retardation at a wavelength λ, respectively. Unless otherwise specified, it is assumed that the wavelength λ is 550 nm.

In the present invention, Re(λ) and Rth(λ) are values measured at the wavelength λ in AxoScan (manufactured by Axometrics, Inc.). By inputting an average refractive index ((nx+ny+nz)/3) and a film thickness (d (μm)) to AxoScan, the following expressions

$$Slow Axis Direction ( ° )$$

$$Re ( λ ) = R 0 ( λ ) , and Rth ( λ ) = ( ( n x + n y ) / 2 - nz ) \times d$$

are calculated.
R0(λ) is expressed as a numerical value calculated by AxoScan and represents Re(λ).

In addition, in the present specification, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and an interference filter.

In addition, values in Polymer Handbook (John Wiley & Sons, Inc.) and catalogs of various optical films can be used. The values of average refractive index of major optical films are as follows: cellulose acylate (1.48), cycloolefin polymer (1.52), polycarbonate (1.59), polymethyl methacrylate (1.49), and polystyrene (1.59).

In addition, in the present specification, materials that correspond to each component may be used alone or in combination of two or more kinds. Here, in a case where two or more kinds of materials are used in combination for each component, the content of the component refers to the total content of the materials to be combined unless specified otherwise.

In addition, in the present specification, “(meth)acrylate” represents “acrylate” or “methacrylate”, “(meth)acryl” represents “acryl” or “methacryl”, and “(meth)acryloyl” represents “acryloyl” or “methacryloyl”.

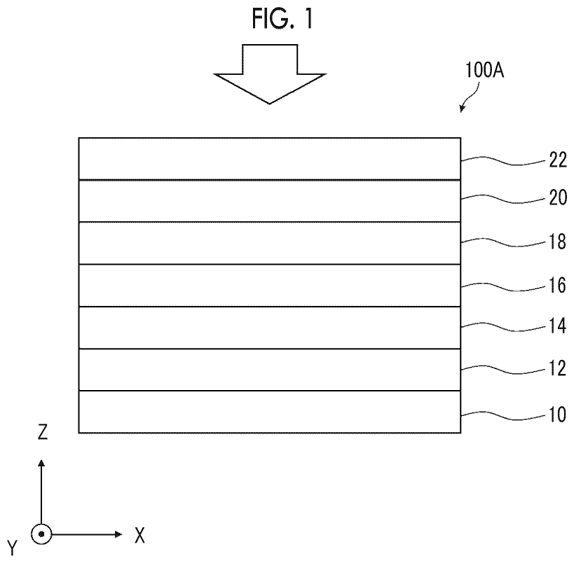

FIG. 1 shows a first embodiment of a viewing angle control system according to the present invention.

A viewing angle control system 100A shown in FIG. 1 includes a first polarizer 10, a first optical compensation layer 12, a first liquid crystal cell 14, a second polarizer 16, a second liquid crystal cell 18, a second optical compensation layer 20, and a third polarizer 22 in this order. In a case where the viewing angle control system 100A is disposed on a light source and each of the first liquid crystal cell 14 and the second liquid crystal cell 18 is applied with a voltage to enter an ON state, a high brightness in the front direction and a low brightness in an oblique direction at a specific azimuthal angle can be realized.

Hereinafter, first, a viewing angle control by the first polarizer 10, the second polarizer 16, the third polarizer 22, the first liquid crystal cell 14, and the second liquid crystal cell 18 will be described.

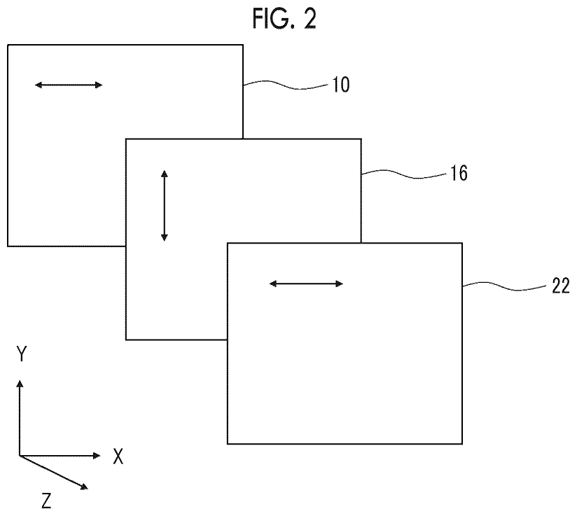

FIG. 2 is a diagram showing a relationship between a transmission axis of the first polarizer 10, a transmission axis of the second polarizer 16, and a transmission axis of the third polarizer 22 in the viewing angle control system 100A shown in FIG. 1 in observation from a white arrow direction of FIG. 1. Arrows in the first polarizer 10, the second polarizer 16, and the third polarizer 22 in FIG. 2 represent the transmission axes.

An angle between the transmission axis of the first polarizer 10 and the transmission axis of the second polarizer 16 is 90°. The present invention is not limited to the aspect of FIG. 1, and the angle between the transmission axis of the first polarizer and the transmission axis of the second polarizer is preferably in a range of 85° to 95° and more preferably in a range of 88° to 92°. That is, it is preferable that the transmission axis of the first polarizer and the transmission axis of the second polarizer are orthogonal to each other.

An angle between the transmission axis of the second polarizer 16 and the transmission axis of the third polarizer 22 is 90°. The present invention is not limited to the aspect of FIG. 1, and the angle between the transmission axis of the second polarizer and the transmission axis of the third polarizer is preferably in a range of 85° to 95° and more preferably in a range of 88° to 92°. That is, it is preferable that the transmission axis of the second polarizer and the transmission axis of the third polarizer are orthogonal to each other.

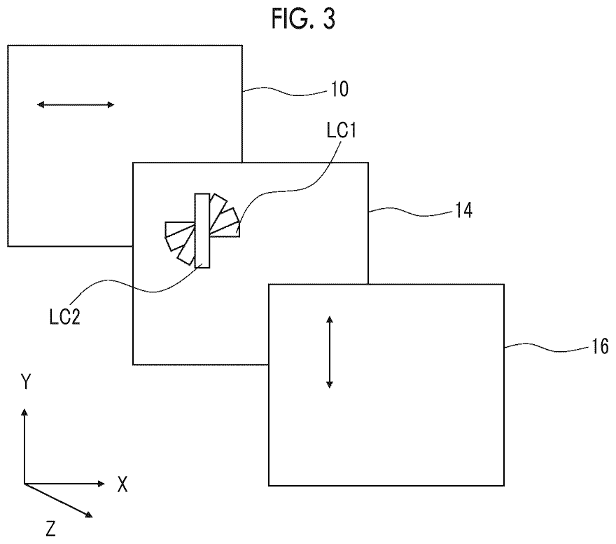

FIG. 3 is a diagram showing a relationship between the transmission axis of the first polarizer 10, a rod-like liquid crystal compound in a liquid crystal layer of the first liquid crystal cell 14, and the transmission axis of the second polarizer 16 in the viewing angle control system 100A shown in FIG. 1 in the observation from the white arrow direction of FIG. 1. In FIG. 3, arrows in the first polarizer 10 and the second polarizer 16 represent the transmission axes.

In FIG. 3, an initial alignment state of a liquid crystal compound in an OFF state where a voltage is not applied to the liquid crystal layer of the first liquid crystal cell 14 is shown. The first liquid crystal cell 14 is a so-called TN-mode liquid crystal cell.

As described above, the angle between the transmission axis of the first polarizer 10 and the transmission axis of the second polarizer 16 is 90°.

The rod-like liquid crystal compound in the liquid crystal layer of the first liquid crystal cell 14 is twist-aligned. More specifically, the rod-like liquid crystal compound is twist-aligned clockwise with respect to a rod-like liquid crystal compound LC2 positioned on the second polarizer 16 side in the liquid crystal layer of the first liquid crystal cell 14.

Hereinafter, the disposition of the rod-like liquid crystal compound will be described.

An angle between a major axis direction of a rod-like liquid crystal compound LC1 that is provided in the liquid crystal layer of the first liquid crystal cell 14 and positioned on the first polarizer 10 side and the transmission axis of the first polarizer 10 is 0°. The present invention is not limited to the aspect of FIG. 3, and the angle between the major axis direction of the rod-like liquid crystal compound that is provided in the liquid crystal layer of the first liquid crystal cell and positioned on the first polarizer side and the transmission axis of the first polarizer is preferably in a range of 0° to 5° and more preferably in a range of 0° to 2°. That is, it is preferable that the major axis direction of the rod-like liquid crystal compound that is provided in the liquid crystal layer of the first liquid crystal cell and positioned on the first polarizer side and the transmission axis of the first polarizer are parallel to each other.

An angle between a major axis direction of the rod-like liquid crystal compound LC2 that is provided in the liquid crystal layer of the first liquid crystal cell 14 and positioned on the second polarizer 16 side and the transmission axis of the second polarizer 16 is 0°. The present invention is not limited to the aspect of FIG. 3, and the angle between the major axis direction of the rod-like liquid crystal compound that is provided in the liquid crystal layer of the first liquid crystal cell and positioned on the second polarizer side and the transmission axis of the second polarizer is preferably in a range of 0° to 5° and more preferably in a range of 0° to 2°. That is, it is preferable that the major axis direction of the rod-like liquid crystal compound that is provided in the liquid crystal layer of the first liquid crystal cell and positioned on the second polarizer side and the transmission axis of the second polarizer are parallel to each other.

As described above, in FIG. 3, the rod-like liquid crystal compound is twist-aligned, and a twisted angle thereof is 90°. The present invention is not limited to the aspect of FIG. 3, and the twisted angle is preferably in a range of 85° to 95° and more preferably in a range of 88° to 92°.

In FIG. 3, the rod-like liquid crystal compound is twist-aligned clockwise but may be twist-aligned counterclockwise.

As described below, the liquid crystal compound in the liquid crystal layer of the first liquid crystal cell may have a predetermined pretilt angle.

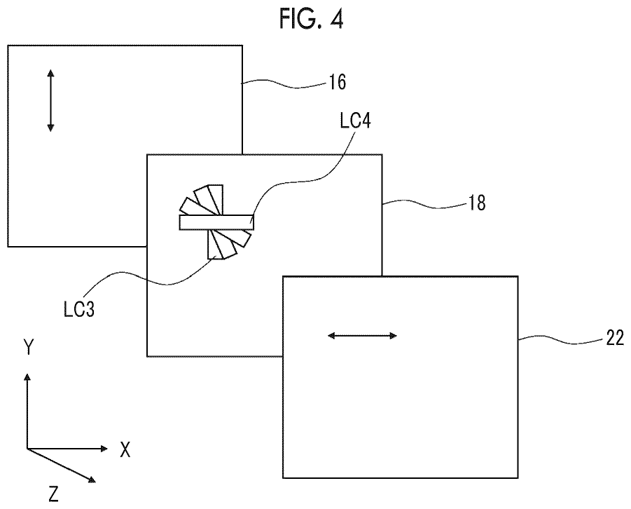

FIG. 4 is a diagram showing a relationship between the transmission axis of the second polarizer 16, the rod-like liquid crystal compound in the liquid crystal layer of the second liquid crystal cell 18, and the transmission axis of the third polarizer 22 in the viewing angle control system 100A shown in FIG. 1 in the observation from the white arrow direction of FIG. 1. In FIG. 4, arrows in the second polarizer 16 and the third polarizer 22 represent the transmission axes.

In FIG. 4, an initial alignment state of a liquid crystal compound in an OFF state where a voltage is not applied to the liquid crystal layer of the second liquid crystal cell 18 is shown. The second liquid crystal cell 18 is a so-called TN-mode liquid crystal cell.

As described above, the angle between the transmission axis of the second polarizer 16 and the transmission axis of the third polarizer 22 is 90°.

The rod-like liquid crystal compound in the liquid crystal layer of the second liquid crystal cell 18 is twist-aligned. More specifically, the rod-like liquid crystal compound is twist-aligned clockwise with respect to a rod-like liquid crystal compound LC4 positioned on the third polarizer 22 side in the liquid crystal layer of the second liquid crystal cell 18.

Hereinafter, the disposition of the rod-like liquid crystal compound will be described.

An angle between a major axis direction of a rod-like liquid crystal compound LC3 that is provided in the liquid crystal layer of the second liquid crystal cell 18 and positioned on the second polarizer 16 side and the transmission axis of the second polarizer 16 is 0°. The present invention is not limited to the aspect of FIG. 4, and the angle between the major axis direction of the rod-like liquid crystal compound that is provided in the liquid crystal layer of the second liquid crystal cell and positioned on the second polarizer side and the transmission axis of the second polarizer is preferably in a range of 0° to 5° and more preferably in a range of 0° to 2°. That is, it is preferable that the major axis direction of the rod-like liquid crystal compound that is provided in the liquid crystal layer of the second liquid crystal cell and positioned on the second polarizer side and the transmission axis of the second polarizer are parallel to each other.

An angle between a major axis direction of the rod-like liquid crystal compound LC4 that is provided in the liquid crystal layer of the second liquid crystal cell 18 and positioned on the third polarizer 22 side and the transmission axis of the third polarizer 22 is 0°. The present invention is not limited to the aspect of FIG. 4, and the angle between the major axis direction of the rod-like liquid crystal compound that is provided in the liquid crystal layer of the second liquid crystal cell and positioned on the third polarizer side and the transmission axis of the third polarizer is preferably in a range of 0° to 5° and more preferably in a range of 0° to 2°. It is preferable that the major axis direction of the rod-like liquid crystal compound that is provided in the liquid crystal layer of the first liquid crystal cell and positioned on the third polarizer side and the transmission axis of the third polarizer are parallel to each other.

As described above, in FIG. 4, the rod-like liquid crystal compound is twist-aligned, and a twisted angle thereof is 90°. The present invention is not limited to the aspect of FIG. 4, and the twisted angle is preferably in a range of 85° to 95° and more preferably in a range of 88° to 92°.

In FIG. 4, the rod-like liquid crystal compound is twist-aligned clockwise but may be twist-aligned counterclockwise.

As described below, the liquid crystal compound in the liquid crystal layer of the second liquid crystal cell may have a predetermined pretilt angle.

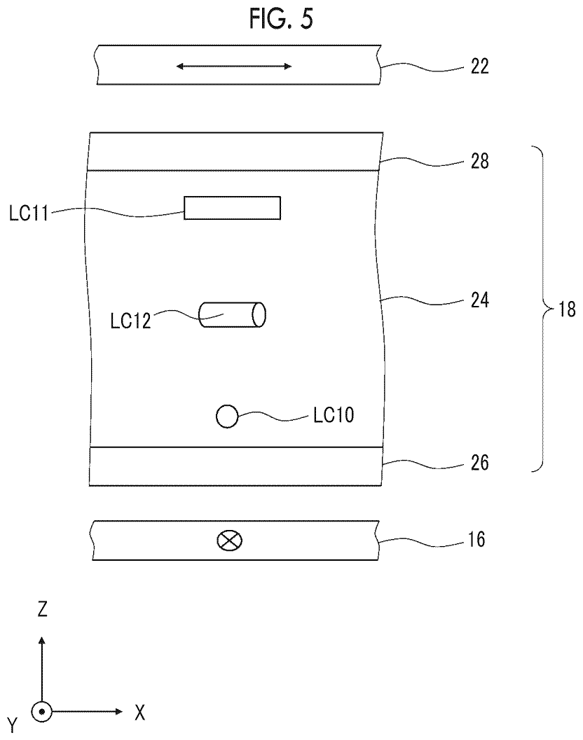

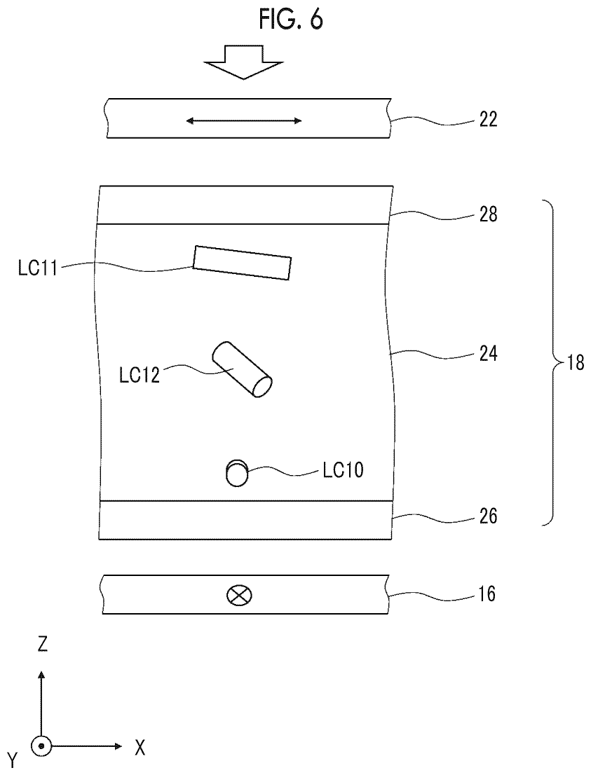

FIGS. 5 and 6 are diagrams showing an alignment state of a rod-like liquid crystal compound in a liquid crystal layer 24 of the second liquid crystal cell 18. In FIGS. 5 and 6, a rod-like liquid crystal compound LC10 that is provided in the liquid crystal layer 24 of the second liquid crystal cell 18 and positioned on the second polarizer 16 side, a rod-like liquid crystal compound LC11 that is provided in the liquid crystal layer 24 of the second liquid crystal cell 18 and positioned on the third polarizer 22 side, and a rod-like liquid crystal compound LC12 that is provided in the liquid crystal layer 24 of the second liquid crystal cell 18 and positioned at an intermediate position of the thickness of the liquid crystal layer 24 are representatively shown. As described above, the rod-like liquid crystal compound is twist-aligned.

As described below, the second liquid crystal cell 18 includes the liquid crystal layer 24 that is interposed between two substrates (a first substrate 26 and a second substrate 28). The configuration of the second liquid crystal cell 18 will be described below in detail.

In FIG. 5, an initial alignment state of a rod-like liquid crystal compound LC in an OFF state where a voltage is not applied to the liquid crystal layer 24 of the second liquid crystal cell 18 is shown.

In FIG. 5, in the OFF state where a voltage is not applied, the rod-like liquid crystal compounds (rod-like liquid crystal compounds LC10 to LC12) are horizontally aligned. As described above, the twisted angle of the rod-like liquid crystal compound is 90°.

In FIG. 5, the rod-like liquid crystal compounds LC10 and LC11 are horizontally aligned but may have a tilt angle.

FIG. 6 shows an alignment state of the rod-like liquid crystal compound LC in an ON state where a voltage is applied to the liquid crystal layer 24 of the second liquid crystal cell 18. FIG. 6 shows an alignment state in a case where a voltage (for example, about 2.5 V) that is about ½ of a maximum voltage is applied.

As shown in FIG. 6, in a case where the above-described voltage is applied, the rod-like liquid crystal compound is tilt-aligned. In particular, as shown in FIG. 6, the rod-like liquid crystal compound LC12 positioned at the intermediate position of the liquid crystal layer 24 is likely to be tilted due to the effect of the voltage. In this case, the azimuthal angle in the major axis direction of the rod-like liquid crystal compound LC12 does not substantially change.

On the other hand, the rod-like liquid crystal compound LC10 positioned on the second polarizer 16 side and the rod-like liquid crystal compound LC11 positioned on the third polarizer 22 side are not likely to be tilted.

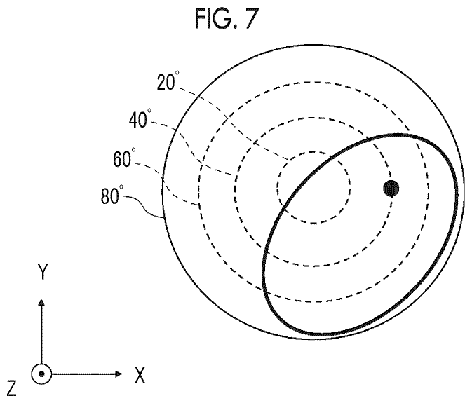

In the configuration of the second polarizer 16, the second liquid crystal cell 18, and the third polarizer 22 shown in FIG. 6, in a case where a light source is disposed on the side of the second polarizer 16 opposite to the second liquid crystal cell 18 side and a voltage is applied to the liquid crystal layer 24 of the second liquid crystal cell 18 such that the rod-like liquid crystal compound is tilted as shown in FIG. 6. FIG. 7 shows a result of visually recognizing light while changing an azimuthal angle and a polar angle from a white arrow direction shown in FIG. 6.

An orientation on the right side of the paper plane in FIG. 7 corresponds to the front end side of the arrow of the X-axis in FIG. 6, a direction on the left side of the paper plane in FIG. 7 corresponds to the rear end side of the arrow of the X-axis in FIG. 6, an orientation on the lower side of the paper plane in FIG. 7 corresponds to the front side of the paper plane in FIG. 6, and an orientation on the upper side of the paper plane in FIG. 7 corresponds to the depth side of the paper plane in FIG. 6.

In addition, the center of a concentric circle corresponds to the normal direction of the second liquid crystal cell 18, and concentric circles having different sizes correspond to tilt angles (polar angles) of 20°, 40°, 60°, and 80° with respect to the normal direction, respectively.

In FIG. 7, as described above, in the configuration of the second polarizer 16, the second liquid crystal cell 18, and the third polarizer 22, the result of disposing the light source on the side of the second polarizer 16 opposite to the second liquid crystal cell 18 side and visually recognizing light while changing the azimuthal angle and the polar angle from the third polarizer 22 side is shown. For example, a black circle in FIG. 7 corresponds to a position of a result of visually recognizing light from a polar angle of 40° along an azimuthal angle toward the front end side of the X-axis direction.

As a result, in a range indicated by a thick line of FIG. 7, light from the light source disposed on the side of the second polarizer 16 opposite to the second liquid crystal cell 18 side is visually recognized, and light from the light source in the other region is not likely to be visually recognized or is not visually recognized. More specifically, in a case where light is visually recognized while changing a polar angle from an intermediate azimuthal angle between the azimuthal angle of the front end side of the X-axis direction in FIG. 6 and the azimuthal angle of the front side of the paper plane in FIG. 6, the liquid crystal layer 24 functions as a retardation layer such as a λ/2 plate due to the effect of the alignment of the rod-like liquid crystal compound in the liquid crystal layer 24 of the second liquid crystal cell 18, and a direction of polarized light transmitted through the second polarizer 16 is rotated to be parallel to a transmission axis direction of the third polarizer 22 such that the light transmits through the third polarizer 22 and is visually recognized. On the other hand, in a case where light is visually recognized while changing a polar angle from an intermediate azimuthal angle between the azimuthal angle of the rear end side of the X-axis direction in FIG. 6 and the azimuthal angle of the depth side of the paper plane in FIG. 6, a retardation by the rod-like liquid crystal compound in the liquid crystal layer 24 of the second liquid crystal cell 18 does not substantially occur. Therefore, unlike the above description, the liquid crystal layer 24 does not function as a retardation layer, and polarized light transmitted through the second polarizer 16 is absorbed by the third polarizer 22 and is not visually recognized.

That is, in the configuration of the second polarizer 16, the second liquid crystal cell 18, and the third polarizer 22, transmission of light in a specific direction can be allowed by applying a voltage to the liquid crystal layer 24 of the second liquid crystal cell 18.

In FIG. 7, the function in the configuration of the second polarizer 16, the second liquid crystal cell 18, and the third polarizer 22 has been described. However, the same also applies to the function in the configuration of the first polarizer 10, the first liquid crystal cell 14, and the second polarizer 16.

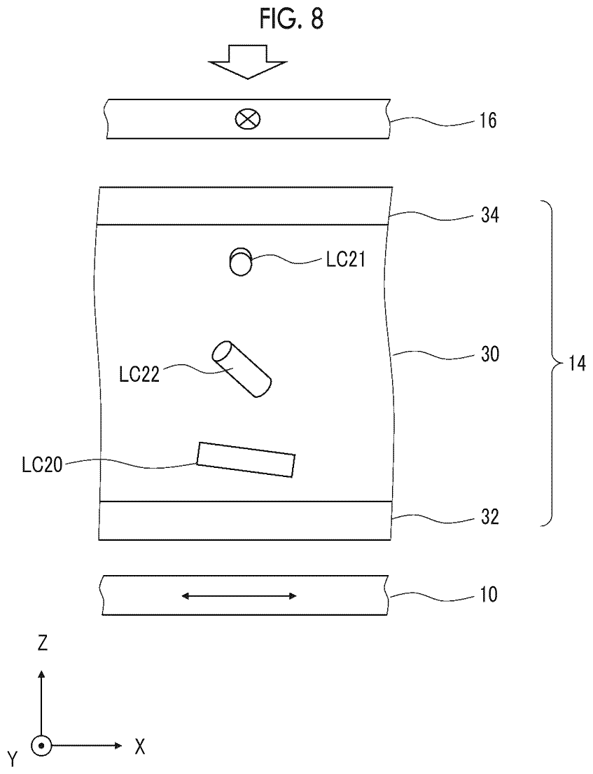

FIG. 8 is a diagram showing an alignment state of a rod-like liquid crystal compound in a liquid crystal layer 30 of the first liquid crystal cell 14. In FIG. 8, a rod-like liquid crystal compound LC20 that is provided in the liquid crystal layer 30 of the first liquid crystal cell 14 and positioned on the first polarizer 10 side, a rod-like liquid crystal compound LC21 that is provided in the liquid crystal layer 30 of the first liquid crystal cell 14 and positioned on the second polarizer 16 side, and a rod-like liquid crystal compound LC22 that is provided in the liquid crystal layer 30 of the first liquid crystal cell 14 and positioned at an intermediate position of the thickness of the liquid crystal layer 30 are representatively shown. As described above, the rod-like liquid crystal compound is twist-aligned.

As described below, the first liquid crystal cell 14 includes the liquid crystal layer 30 that is interposed between two substrates (a first substrate 32 and a second substrate 34). The configuration of the first liquid crystal cell 14 will be described below in detail.

FIG. 8 shows an alignment state of the rod-like liquid crystal compound LC in an ON state where a voltage is applied to the liquid crystal layer 30 of the first liquid crystal cell 14. FIG. 8 shows an alignment state in a case where a voltage (for example, about 2.5 V) that is about ½ of a maximum voltage is applied.

As shown in FIG. 8, in a case where the above-described voltage is applied, the rod-like liquid crystal compound is tilt-aligned. In particular, as shown in FIG. 8, the rod-like liquid crystal compound LC22 positioned at the intermediate position of the liquid crystal layer 30 is likely to be tilted due to the effect of the voltage. In this case, the azimuthal angle in the major axis direction of the rod-like liquid crystal compound LC22 does not substantially change.

On the other hand, the rod-like liquid crystal compound LC20 positioned on the first polarizer 10 side and the rod-like liquid crystal compound LC21 positioned on the second polarizer 16 side are not likely to be tilted.

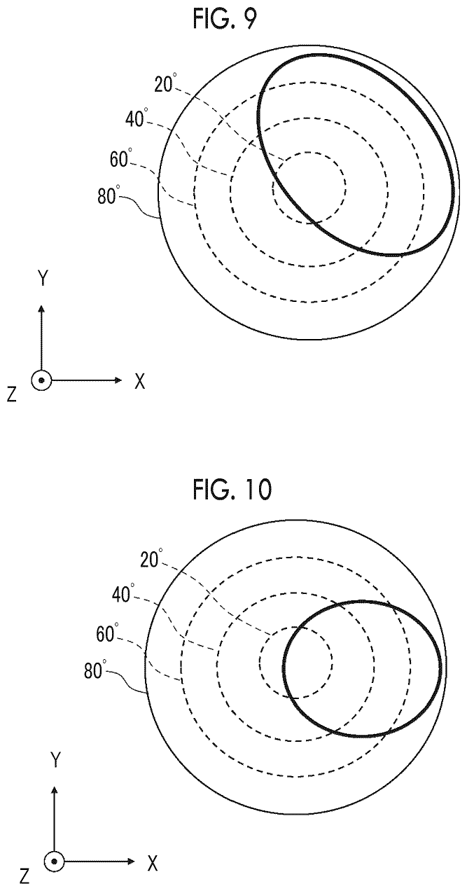

In the configuration of the first polarizer 10, the first liquid crystal cell 14, and the second polarizer 16 shown in FIG. 8, in a case where a light source is disposed on the side of the first polarizer 10 opposite to the first liquid crystal cell 14 side and a voltage is applied to the liquid crystal layer of the first liquid crystal cell 14 such that the rod-like liquid crystal compound is tilted, FIG. 9 shows a result of visually recognizing light while changing an azimuthal angle and a polar angle from a white arrow direction shown in FIG. 8.

An orientation on the right side of the paper plane in FIG. 9 corresponds to the front end side of the arrow of the X-axis in FIG. 8, a direction on the left side of the paper plane in FIG. 9 corresponds to the rear end side of the arrow of the X-axis in FIG. 8, an orientation on the lower side of the paper plane in FIG. 9 corresponds to the front side of the paper plane in FIG. 8, and an orientation on the upper side of the paper plane in FIG. 9 corresponds to the depth side of the paper plane in FIG. 8.

In addition, the center of a concentric circle corresponds to the normal direction of the first liquid crystal cell 14, and concentric circles having different sizes correspond to tilt angles (polar angles) of 20°, 40°, 60°, and 80° with respect to the normal direction, respectively.

In FIG. 9, as described above, in the configuration of the first polarizer 10, the first liquid crystal cell 14, and the second polarizer 16, the result of disposing the light source on the side of the first polarizer 10 opposite to the first liquid crystal cell 14 side and visually recognizing light while changing the azimuthal angle and the polar angle from the second polarizer 16 side is shown.

As a result, in a range indicated by a thick line of FIG. 9, light from the light source disposed on the side of the first polarizer 10 opposite to the first liquid crystal cell 14 side is visually recognized, and light from the light source in the other region is not likely to be visually recognized or is not visually recognized.

That is, in the configuration of the first polarizer 10, the first liquid crystal cell 14, and the second polarizer 16, transmission of light in a specific direction can be allowed by applying a voltage to the liquid crystal layer 30 of the first liquid crystal cell 14.

As described above, with each of the configuration of the first polarizer 10, the first liquid crystal cell 14, and the second polarizer 16 and the configuration of the second polarizer 16, the second liquid crystal cell 18, and the third polarizer 22, a viewing angle can be controlled.

Therefore, in a case where the above-described two configurations are combined in the thickness direction such that both of the powers of the first liquid crystal cell 14 and the second liquid crystal cell 18 enter an ON state, As shown in FIG. 10, light of the light source can be visually recognized in a range where the ranges surrounded by the thick lines in FIGS. 7 and 9 overlap each other.

This mechanism is also described in JP2021-156943A.

On the other hand, as shown in FIG. 6 above, even in a case where a voltage is applied to the liquid crystal layer 24 of the second liquid crystal cell 18, the rod-like liquid crystal compound LC10 and the rod-like liquid crystal compound LC11 are not likely to be tilt-aligned unlike the rod-like liquid crystal compound LC12. In a case where the rod-like liquid crystal compound LC10 and the rod-like liquid crystal compound LC11 are included, the function as the retardation layer of the liquid crystal layer 24 decreases, which may cause light leak in the viewing angle control system. In particular, the present inventors found that the effect of the rod-like liquid crystal compound LC11 is large.

In the present invention, by providing the second optical compensation layer 20 shown in FIG. 1, the above-described light leak by the rod-like liquid crystal compound LC11 is cancelled.

The second optical compensation layer 20 corresponds to a layer where, in a case where a retardation is measured from a normal direction of the second optical compensation layer and a direction tilted from the normal direction, the retardation is at a minimum in the direction tilted from the normal direction. The description regarding the above-described layer will be described below in detail.

Hereinafter, the reason why the above-described light leak is cancelled will be described below.

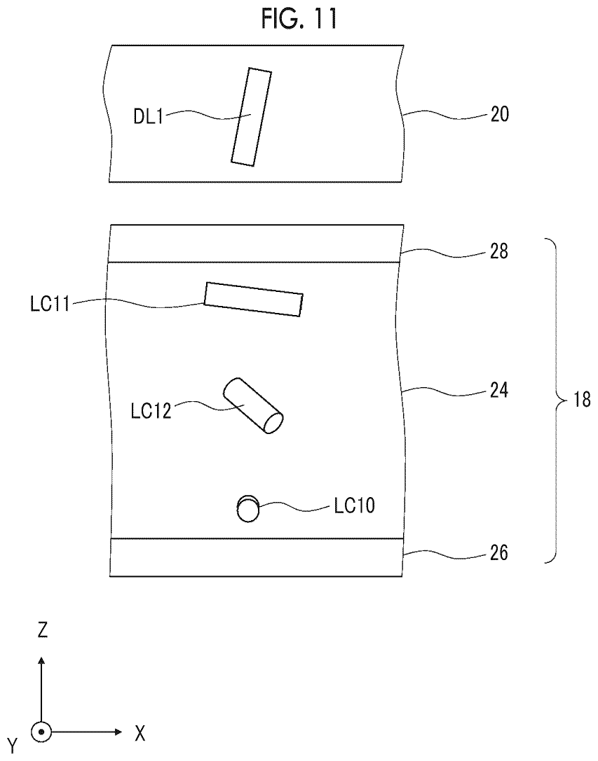

In FIG. 11, the configuration of the second liquid crystal cell 18 and the second optical compensation layer 20 is shown. The second liquid crystal cell 18 is in a state where the power is ON shown in FIG. 6, and as described above, in a case where the power of the second liquid crystal cell 18 is ON, the rod-like liquid crystal compound LC11 is not likely to be tilt-aligned.

On the other hand, by disposing the second optical compensation layer 20 that is a layer obtained by immobilizing a tilt-aligned disk-like liquid crystal compound DL1, the optical effect of the rod-like liquid crystal compound LC11 is cancelled.

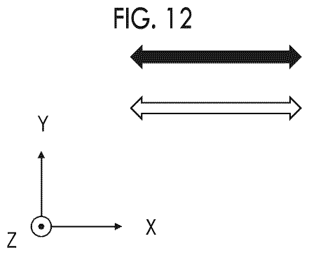

A disk plane of the disk-like liquid crystal compound DL1 is parallel to the front-depth direction of the paper plane, and a projection axis where an optical axis of the disk-like liquid crystal compound DL1 is projected onto a surface (main surface) of the second optical compensation layer 20 is indicated by a black arrow of FIG. 12. The optical axis of the disk-like liquid crystal compound DL1 is an axis along the normal direction of the disk plane of the disk-like liquid crystal compound DL1. In addition, the surface of the second optical compensation layer 20 corresponds to one of two main surfaces orthogonal to the thickness direction of the second optical compensation layer 20. The above-described main surfaces refer to surfaces having the largest area in the second optical compensation layer 20.

In addition, an in-plane slow axis on the surface of the liquid crystal layer 24 of the second liquid crystal cell 18 on the second optical compensation layer 20 side is indicated by a white arrow of FIG. 12. The above-described in-plane slow axis corresponds to a projection axis where the optical axis of the rod-like liquid crystal compound LC11 (the major axis of the rod-like liquid crystal compound LC11) positioned on the second optical compensation layer 20 side of the liquid crystal layer 24 is projected onto the surface of the second optical compensation layer 20.

As shown in FIG. 12, an angle between the black arrow and the white arrow is 0°. That is, in the second optical compensation layer 20, an angle between the projection axis where the optical axis of the disk-like liquid crystal compound DL1 is projected onto the surface of the second optical compensation layer 20 and the in-plane slow axis on the surface of the liquid crystal layer 24 of the second liquid crystal cell 18 on the second optical compensation layer 20 side is 0°. However, the present invention is not limited to this aspect, and the angle between the projection axis where the optical axis of the disk-like liquid crystal compound is projected onto the surface of the second optical compensation layer and the in-plane slow axis on the surface of the liquid crystal layer of the second liquid crystal cell on the second optical compensation layer side is preferably 0° to 45°, more preferably 0° to 20°, still more preferably 0° to 5°, and still more preferably 0° to 2°. That is, the projection axis where the optical axis of the disk-like liquid crystal compound is projected onto the surface of the second optical compensation layer and the in-plane slow axis on the surface of the liquid crystal layer of the second liquid crystal cell on the second optical compensation layer side are preferably parallel to each other.

The angle between the disk plane of the disk-like liquid crystal compound DL1 in the second optical compensation layer 20 and the surface of the second optical compensation layer 20 is not particularly limited and is preferably 10° to 45° and more preferably 15° to 35°.

An angle between an azimuthal angle from one end of the optical axis (major axis) on the side opposite to the second optical compensation layer 20 side toward one end of the optical axis on the second optical compensation layer 20 side in the rod-like liquid crystal compound LC11 that is positioned on the surface of the liquid crystal layer 24 of the second liquid crystal cell 18 on the second optical compensation layer 20 side and an azimuthal angle from one end of the optical axis on the second liquid crystal cell 18 side toward one end of the optical axis on the side opposite to the second liquid crystal cell 18 side in the disk-like liquid crystal compound DL1 is 0°. However, the present invention is not limited to this aspect, and the angle between the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side and the azimuthal angle from one end of the optical axis on the second liquid crystal cell side toward one end of the optical axis on the side opposite to the second liquid crystal cell side in the disk-like liquid crystal compound is preferably 0° to 45°, more preferably 0° to 20°, still more preferably 0° to 5°, and still more preferably 0° to 2°. That is, the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side and the azimuthal angle from one end of the optical axis on the second liquid crystal cell side toward one end of the optical axis on the side opposite to the second liquid crystal cell side in the disk-like liquid crystal compound are preferably parallel to each other.

The above-described azimuthal angle refers to an azimuthal angle on an xy plane in FIG. 11.

In the aspect shown in FIG. 11, the aspect where the second optical compensation layer 20 includes the disk-like liquid crystal compound DL1 has been described. An aspect where the second optical compensation layer includes a rod-like liquid crystal compound may also be adopted. In a case where the second optical compensation layer includes a rod-like liquid crystal compound, the angle between the projection axis where an optical axis of the rod-like liquid crystal compound is projected onto the surface of the second optical compensation layer and the in-plane slow axis on the surface of the liquid crystal layer of the second liquid crystal cell on the second optical compensation layer side is preferably 0° to 45°, more preferably 0° to 20°, still more preferably 0° to 5°, and still more preferably 0° to 2°.

In a case where the second optical compensation layer includes a rod-like liquid crystal compound, an angle between the major axis of the rod-like liquid crystal compound and the surface of the second optical compensation layer is not particularly limited and is preferably 10° to 45° and more preferably 15° to 35°.

In a case where the second optical compensation layer includes a rod-like liquid crystal compound, the angle between the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side and the azimuthal angle from one end of the optical axis on the second liquid crystal cell side toward one end of the optical axis on the side opposite to the second liquid crystal cell side in the rod-like liquid crystal compound of the second optical compensation layer is preferably 135° to 225°, more preferably 160° to 200°, and still more preferably 175° to 185°.

In addition, as shown in FIG. 8 above, even in a case where a voltage is applied to the liquid crystal layer 30 of the first liquid crystal cell 14, the rod-like liquid crystal compound LC20 and the rod-like liquid crystal compound LC21 are not likely to be tilt-aligned unlike the rod-like liquid crystal compound LC22. In a case where the rod-like liquid crystal compound LC20 and the rod-like liquid crystal compound LC21 are included, the function as the retardation layer of the liquid crystal layer 30 decreases, which may cause light leak in the viewing angle control system. In particular, the present inventors found that the effect of the rod-like liquid crystal compound LC20 is large.

In the present invention, by providing the first optical compensation layer 12 shown in FIG. 1, the above-described light leak by the rod-like liquid crystal compound LC20 is cancelled.

As in the second optical compensation layer 20 shown in FIG. 11, the first optical compensation layer 12 is a layer obtained by immobilizing a tilt-aligned disk-like liquid crystal compound, and the optical effect of the rod-like liquid crystal compound LC20 is cancelled.

An angle between a projection axis where an optical axis of the disk-like liquid crystal compound in the first optical compensation layer 12 is projected onto a surface (main surface) of the first optical compensation layer 12 and an in-plane slow axis on a surface of a liquid crystal layer of the first liquid crystal cell 14 on the first optical compensation layer 12 side is 0°. In addition, the surface of the first optical compensation layer 12 corresponds to one of two main surfaces orthogonal to the thickness direction of the first optical compensation layer 12. The above-described main surfaces refer to surfaces having the largest area in the first optical compensation layer 12.

However, the present invention is not limited to this aspect, and the angle between the projection axis where the optical axis of the disk-like liquid crystal compound is projected onto the surface of the first optical compensation layer and the in-plane slow axis on the surface of the liquid crystal layer of the first liquid crystal cell on the first optical compensation layer side is preferably 0° to 45°, more preferably 0° to 20°, still more preferably 0° to 5°, and still more preferably 0° to 2°. That is, the projection axis where the optical axis of the disk-like liquid crystal compound is projected onto the surface of the disk-like liquid crystal compound in the first optical compensation layer and the in-plane slow axis on the surface of the liquid crystal layer of the first liquid crystal cell on the first optical compensation layer side are preferably parallel to each other.

The angle between the disk plane of the disk-like liquid crystal compound in the first optical compensation layer and the surface of the first optical compensation layer is not particularly limited and is preferably 10° to 45° and more preferably 15° to 35°.

An angle between an azimuthal angle from one end of the optical axis (major axis) on the first optical compensation layer 12 side toward one end of the optical axis on the side opposite to the first optical compensation layer 12 side in the rod-like liquid crystal compound LC20 that is positioned on the surface of the liquid crystal layer 30 of the first liquid crystal cell 14 on the first optical compensation layer 12 side and an azimuthal angle from one end of the optical axis on the side opposite to the first liquid crystal cell 14 side toward one end of the optical axis on the first liquid crystal cell 14 side in the disk-like liquid crystal compound of the first optical compensation layer 12 is 0°. However, the present invention is not limited to this aspect, and the angle between the azimuthal angle from one end of the optical axis (major axis) on the first optical compensation layer side toward one end of the optical axis on the side opposite to the first optical compensation layer side in the rod-like liquid crystal compound that is positioned on the surface of the liquid crystal layer of the first liquid crystal cell on the first optical compensation layer side and the azimuthal angle from one end of the optical axis on the side opposite to the first liquid crystal cell side toward one end of the optical axis on the first liquid crystal cell side in the disk-like liquid crystal compound of the first optical compensation layer is preferably 0° to 45°, more preferably 0° to 20°, still more preferably 0° to 5°, and still more preferably 0° to 2°. That is, the azimuthal angle from one end of the optical axis (major axis) on the first optical compensation layer side toward one end of the optical axis on the side opposite to the first optical compensation layer side in the rod-like liquid crystal compound that is positioned on the surface of the liquid crystal layer of the first liquid crystal cell on the first optical compensation layer side and the azimuthal angle from one end of the optical axis on the side opposite to the first liquid crystal cell side toward one end of the optical axis on the first liquid crystal cell side in the disk-like liquid crystal compound of the first optical compensation layer are preferably parallel to each other.

In the above description, the aspect where the first optical compensation layer includes the disk-like liquid crystal compound has been described. An aspect where the first optical compensation layer includes a rod-like liquid crystal compound may also be adopted. In a case where the first optical compensation layer includes a rod-like liquid crystal compound, the angle between the projection axis where the optical axis of the rod-like liquid crystal compound is projected onto the surface of the first optical compensation layer and the in-plane slow axis on the surface of the liquid crystal layer of the first liquid crystal cell on the first optical compensation layer side is preferably in the above-described range.

In a case where the first optical compensation layer includes a rod-like liquid crystal compound, an angle between the major axis of the rod-like liquid crystal compound and the surface of the first optical compensation layer is not particularly limited and is preferably 10° to 45° and more preferably 15° to 35°.

In a case where the first optical compensation layer includes a rod-like liquid crystal compound, the angle between the azimuthal angle from one end of the optical axis (major axis) on the first optical compensation layer side toward one end of the optical axis on the side opposite to the first optical compensation layer side in the rod-like liquid crystal compound that is positioned on the surface of the liquid crystal layer of the first liquid crystal cell on the first optical compensation layer side and the azimuthal angle from one end of the optical axis on the side opposite to the first liquid crystal cell side toward one end of the optical axis on the first liquid crystal cell side in the rod-like liquid crystal compound of the first optical compensation layer is preferably 135° to 225°, more preferably 160° to 200°, and still more preferably 175° to 185°.

Examples of a modification example of the first embodiment of the viewing angle control system according to the present invention include an aspect where an orientation of an optical axis of a liquid crystal compound in the first optical compensation layer and/or the second optical compensation layer is different.

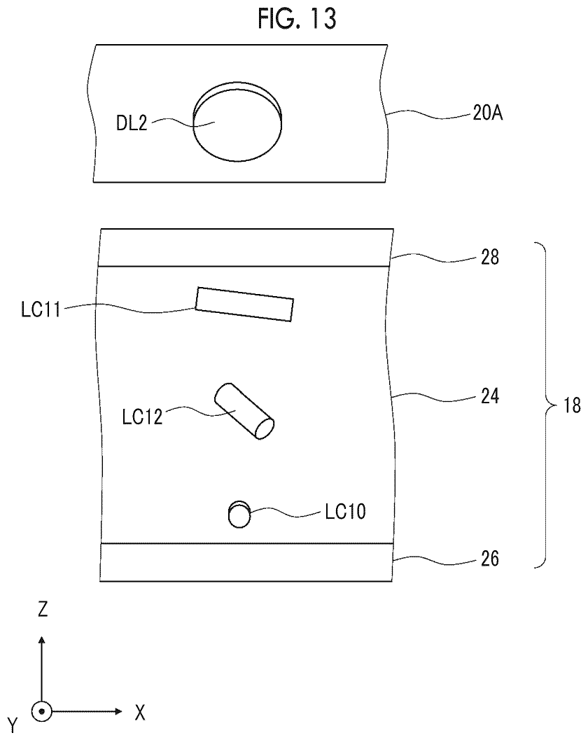

More specifically, in FIG. 13, the modification example corresponds to an aspect including the configuration of the viewing angle control system described above in the first embodiment, except that a second optical compensation layer 20A is used.

The second optical compensation layer 20A is a layer obtained by immobilizing a tilt-aligned disk-like liquid crystal compound DL2, and an orientation of an optical axis of the disk-like liquid crystal compound is different from that of the second optical compensation layer 20 shown in FIG. 11.

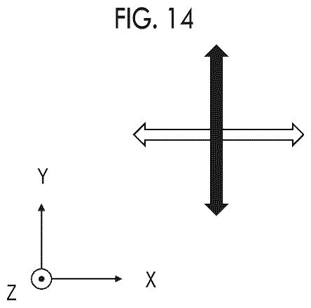

In the configuration shown in FIG. 13, a projection axis where the optical axis of the disk-like liquid crystal compound DL2 is projected onto a surface (main surface) of the second optical compensation layer 20A is indicated by a black arrow of FIG. 14. The optical axis of the disk-like liquid crystal compound DL2 is an axis along the normal direction of the disk plane of the disk-like liquid crystal compound DL2.

In addition, an in-plane slow axis on the surface of the liquid crystal layer 24 of the second liquid crystal cell 18 on the second optical compensation layer 20A side is indicated by a white arrow of FIG. 14.

As shown in FIG. 14, an angle between the black arrow and the white arrow is 90°. That is, in the second optical compensation layer 20A, an angle between the projection axis where the optical axis of the disk-like liquid crystal compound DL2 is projected onto the surface of the second optical compensation layer 20A and the in-plane slow axis on the surface of the liquid crystal layer 24 of the second liquid crystal cell 18 on the second optical compensation layer 20A side is 90°.

The present inventors found that, in the configuration shown in FIG. 13, light leak is further suppressed as compared to the configuration shown in FIG. 10, and thus lower brightness in an oblique direction at a specific azimuthal angle can be achieved.

In FIG. 13, in the second optical compensation layer 20A, the aspect where the angle between the projection axis where the optical axis of the disk-like liquid crystal compound DL2 is projected onto the surface of the second optical compensation layer 20A and the in-plane slow axis on the surface of the liquid crystal layer 24 of the second liquid crystal cell 18 on the second optical compensation layer 20A side is 90° has been described. However, the present invention is not limited to this aspect, and the angle between the projection axis where the optical axis of the disk-like liquid crystal compound is projected onto the surface of the second optical compensation layer and the in-plane slow axis on the surface of the liquid crystal layer of the second liquid crystal cell on the second optical compensation layer side is preferably 45° to 135°, more preferably 70° to 110°, and still more preferably 85° to 95°.

The angle between the disk plane of the disk-like liquid crystal compound DL2 in the second optical compensation layer 20A and the surface of the second optical compensation layer 20A is not particularly limited and is preferably 10° to 45° and more preferably 15° to 35°.

The rod-like liquid crystal compound is twist-aligned clockwise with respect to the rod-like liquid crystal compound positioned on the second optical compensation layer 20A side in the liquid crystal layer 24 of the second liquid crystal cell 18. In this case, with respect to the azimuthal angle from one end of the optical axis on the second liquid crystal cell 18 side toward one end of the optical axis on the side opposite to the second liquid crystal cell 18 side in the disk-like liquid crystal compound DL2, the azimuthal angle from one end of the optical axis (major axis) on the side opposite to the second optical compensation layer 20 side toward one end of the optical axis on the second optical compensation layer 20 side in the rod-like liquid crystal compound LC11 that is positioned on the surface of the liquid crystal layer 24 of the second liquid crystal cell 18 on the second optical compensation layer 20 side is at a position rotated by 90° counterclockwise. However, the present invention is not limited to this aspect, and with respect to the azimuthal angle from one end of the optical axis on the second liquid crystal cell side toward one end of the optical axis on the side opposite to the second liquid crystal cell side in the disk-like liquid crystal compound of the second optical compensation layer, the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side is preferably at a position rotated in a range of 45° to 135° counterclockwise, is more preferably at a position rotated in a range of 70° to 110° counterclockwise, and is still more preferably at a position rotated in a range of 85° to 95° counterclockwise.

The above-described azimuthal angle refers to an azimuthal angle on an xy plane in FIG. 13.

In the above description, the aspect where the rod-like liquid crystal compound in the liquid crystal layer of the second liquid crystal cell is twist-aligned clockwise has been described. However, the present invention is not limited to this aspect, and an aspect where the rod-like liquid crystal compound is twist-aligned counterclockwise may be adopted. In a case where the rod-like liquid crystal compound is twist-aligned counterclockwise, and with respect to the azimuthal angle from one end of the optical axis on the second liquid crystal cell side toward one end of the optical axis on the side opposite to the second liquid crystal cell side in the disk-like liquid crystal compound of the second optical compensation layer, the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side is preferably at a position rotated in a range of 45° to 135° clockwise, is more preferably at a position rotated in a range of 70° to 110° clockwise, and is still more preferably at a position rotated in a range of 85° to 95° clockwise.

In the aspect shown in FIG. 13, the aspect where the second optical compensation layer 20A includes the disk-like liquid crystal compound DL2 has been described. An aspect where the second optical compensation layer includes a rod-like liquid crystal compound may also be adopted. In a case where the second optical compensation layer includes a rod-like liquid crystal compound, the angle between the projection axis where the optical axis of the rod-like liquid crystal compound is projected onto the surface of the second optical compensation layer and the in-plane slow axis on the surface of the liquid crystal layer of the second liquid crystal cell on the second optical compensation layer side is preferably in the above-described range.

Accordingly, the angle between the projection axis where the optical axis of the disk-like liquid crystal compound is projected onto the surface of the second optical compensation layer and the in-plane slow axis on the surface of the liquid crystal layer of the second liquid crystal cell on the second optical compensation layer side is preferably 45° to 135°.

In a case where the second optical compensation layer includes a rod-like liquid crystal compound, an angle between the major axis of the rod-like liquid crystal compound and the surface of the second optical compensation layer is not particularly limited and is preferably 10° to 45° and more preferably 15° to 35°.

In a case where the second optical compensation layer includes a rod-like liquid crystal compound, with respect to the azimuthal angle from one end of the optical axis on the second liquid crystal cell side toward one end of the optical axis on the side opposite to the second liquid crystal cell side in the rod-like liquid crystal compound of the second optical compensation layer, a preferable range of the azimuthal angle from one end of the optical axis (major axis) on the side opposite to the second optical compensation layer side toward one end of the optical axis on the second optical compensation layer side in the rod-like liquid crystal compound that is positioned on the surface of the liquid crystal layer of the second liquid crystal cell on the second optical compensation layer side is the same as the preferable range in a case where the second optical compensation layer includes a disk-like liquid crystal compound.

In the above description, the second optical compensation layer 20A has been described. However, regarding the first optical compensation layer, the same tendency of characteristics are shown.

Specifically, the angle between the projection axis where the optical axis of the disk-like liquid crystal compound is projected onto the surface of the first optical compensation layer and the in-plane slow axis on the surface of the liquid crystal layer of the first liquid crystal cell on the first optical compensation layer side is preferably 45° to 135°, more preferably 70° to 110°, and still more preferably 85° to 95°.

In a case where the liquid crystal compound in the first optical compensation layer is a disk-like liquid crystal compound, the angle between the disk plane of the disk-like liquid crystal compound and the surface of the first optical compensation layer is not particularly limited and is preferably 10° to 45° and more preferably 15° to 35°.

In a case where the liquid crystal compound in the first optical compensation layer is a rod-like liquid crystal compound, the angle between the major axis of the rod-like liquid crystal compound and the surface of the first optical compensation layer is not particularly limited and is preferably 10° to 45° and more preferably 15° to 35°.

The rod-like liquid crystal compound is twist-aligned clockwise with respect to the rod-like liquid crystal compound positioned on the side (second polarizer side) opposite to the first optical compensation layer side in the liquid crystal layer of the first liquid crystal cell.

In this case, with respect to the azimuthal angle from one end of the optical axis on the side opposite to the first liquid crystal cell side toward one end of the optical axis on the first liquid crystal cell side in the liquid crystal compound of the first optical compensation layer, the azimuthal angle from one end of the optical axis (major axis) on the first optical compensation layer side toward one end of the optical axis on the side opposite to the first optical compensation layer side in the rod-like liquid crystal compound that is positioned on the surface of the liquid crystal layer of the first liquid crystal cell on the first optical compensation layer side is preferably at a position rotated in a range of 45° to 135° clockwise, is more preferably at a position rotated in a range of 70° to 110° clockwise, and is still more preferably at a position rotated in a range of 85° to 95° clockwise.

In the above description, the aspect where the rod-like liquid crystal compound in the liquid crystal layer of the first liquid crystal cell is twist-aligned clockwise has been described. However, the present invention is not limited to this aspect, and an aspect where the rod-like liquid crystal compound is twist-aligned counterclockwise may be adopted. In a case where the rod-like liquid crystal compound is twist-aligned counterclockwise, with respect to the azimuthal angle from one end of the optical axis on the side opposite to the first liquid crystal cell side toward one end of the optical axis on the first liquid crystal cell side in the liquid crystal compound of the first optical compensation layer, the azimuthal angle from one end of the optical axis (major axis) on the first optical compensation layer side toward one end of the optical axis on the side opposite to the first optical compensation layer side in the rod-like liquid crystal compound that is positioned on the surface of the liquid crystal layer of the first liquid crystal cell on the first optical compensation layer side is preferably at a position rotated in a range of 45° to 135° counterclockwise, is more preferably at a position rotated in a range of 70° to 110° counterclockwise, and is still more preferably at a position rotated in a range of 85° to 95° counterclockwise.

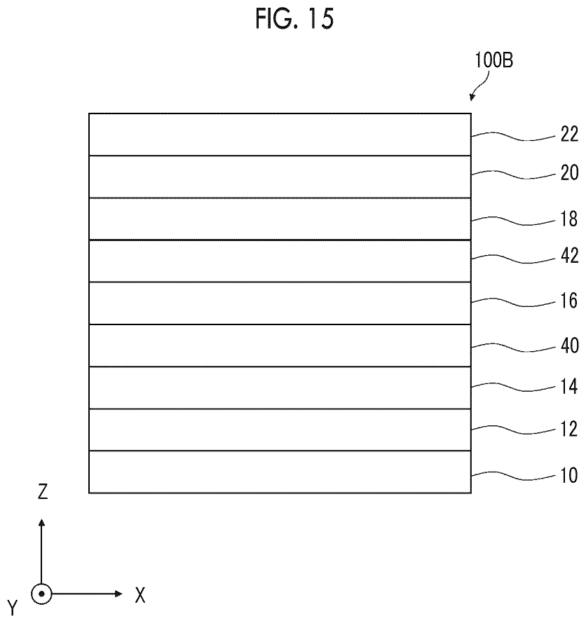

FIG. 15 shows a second embodiment of the viewing angle control system according to the present invention.

A viewing angle control system 100B shown in FIG. 15 includes the first polarizer 10, the first optical compensation layer 12, the first liquid crystal cell 14, a third optical compensation layer 40, the second polarizer 16, a fourth optical compensation layer 42, the second liquid crystal cell 18, the second optical compensation layer 20, and the third polarizer 22 in this order.

The viewing angle control system 100B has the same configuration as the viewing angle control system 100A, except that it includes the third optical compensation layer 40 and the fourth optical compensation layer 42. In a case where the viewing angle control system 100B is disposed on a light source and each of the first liquid crystal cell 14 and the second liquid crystal cell 18 is applied with a voltage to enter an ON state, a high brightness in the front direction and a low brightness in an oblique direction at a specific azimuthal angle can be realized. In particular, in the viewing angle control system 100B, by further providing the third optical compensation layer 40 and the fourth optical compensation layer 42, the effect of the present invention is further improved.

The third optical compensation layer 40 is a layer obtained by immobilizing a tilt-aligned disk-like liquid crystal compound as in the first optical compensation layer 12 and the second optical compensation layer 20.

As described above, even in a case where the liquid crystal layer 30 is applied with a voltage to enter an ON state, the rod-like liquid crystal compound LC21 shown in FIG. 8 that is provided in the liquid crystal layer 30 of the first liquid crystal cell 14 and positioned on the second polarizer 16 side is not likely to be tilt-aligned.

By providing the third optical compensation layer 40, light leak caused by the rod-like liquid crystal compound LC21 can be suppressed.

An angle between a projection axis where an optical axis of the disk-like liquid crystal compound in the third optical compensation layer 40 is projected onto a surface (main surface) of the third optical compensation layer 40 and an in-plane slow axis on a surface of the liquid crystal layer 30 of the first liquid crystal cell 14 on the third optical compensation layer 40 side is 0°. In addition, the surface of the third optical compensation layer 40 corresponds to one of two main surfaces orthogonal to the thickness direction of the third optical compensation layer 40. The above-described main surfaces refer to surfaces having the largest area in the third optical compensation layer 40.

The present invention is not limited to this aspect, and the angle formed by the projection axis obtained by projecting the optical axis of the liquid crystal compound in the third optical compensation layer onto the surface of the third optical compensation layer and the in-plane slow axis on the surface of the liquid crystal layer on the third optical compensation layer side in the first liquid crystal cell is preferably 0° to 5° and more preferably 0° to 2°. That is, the projection axis where the optical axis of the disk-like liquid crystal compound is projected onto the surface of the disk-like liquid crystal compound in the third optical compensation layer and the in-plane slow axis on the surface of the liquid crystal layer of the first liquid crystal cell 14 on the third optical compensation layer side are preferably parallel to each other.

The angle between the disk plane of the disk-like liquid crystal compound in the third optical compensation layer 40 and the surface of the third optical compensation layer 40 is not particularly limited and is preferably 10° to 45° and more preferably 15° to 35°.

An angle between an azimuthal angle from one end of the optical axis (major axis) on the side opposite to the third optical compensation layer 40 side toward one end of the optical axis on the third optical compensation layer 40 side in the rod-like liquid crystal compound that is positioned on the surface of the liquid crystal layer 30 of the first liquid crystal cell 14 on the third optical compensation layer 40 side and an azimuthal angle from one end of the optical axis on the first liquid crystal cell 14 side toward one end of the optical axis on the side opposite to the first liquid crystal cell 14 side in the disk-like liquid crystal compound of the third optical compensation layer 40 is 0°. However, the present invention is not limited to this aspect, and the angle between the azimuthal angle from one end of the optical axis (major axis) on the side opposite to the third optical compensation layer side toward one end of the optical axis on the third optical compensation layer side in the rod-like liquid crystal compound that is positioned on the surface of the liquid crystal layer of the first liquid crystal cell on the third optical compensation layer side and the azimuthal angle from one end of the optical axis on the first liquid crystal cell side toward one end of the optical axis on the side opposite to the first liquid crystal cell side in the disk-like liquid crystal compound is preferably 0° to 45°, more preferably 0° to 20°, still more preferably 0° to 5°, and still more preferably 0° to 2°. That is, the azimuthal angle from one end of the optical axis (major axis) on the side opposite to the third optical compensation layer side toward one end of the optical axis on the third optical compensation layer side in the rod-like liquid crystal compound that is positioned on the surface of the liquid crystal layer of the first liquid crystal cell on the third optical compensation layer side and the azimuthal angle from one end of the optical axis on the first liquid crystal cell side toward one end of the optical axis on the side opposite to the first liquid crystal cell side in the disk-like liquid crystal compound are preferably parallel to each other.

In the above description, the aspect where the third optical compensation layer 40 includes the disk-like liquid crystal compound has been described. An aspect where the third optical compensation layer includes a rod-like liquid crystal compound may also be adopted. In a case where the third optical compensation layer includes a rod-like liquid crystal compound, the angle between the projection axis where the optical axis of the rod-like liquid crystal compound is projected onto the surface of the third optical compensation layer and the in-plane slow axis on the surface of the liquid crystal layer of the first liquid crystal cell on the third optical compensation layer side is preferably in the above-described range.

In a case where the third optical compensation layer includes a rod-like liquid crystal compound, an angle between the major axis of the rod-like liquid crystal compound and the surface of the third optical compensation layer is not particularly limited and is preferably 10° to 45° and more preferably 15° to 35°.

In a case where the third optical compensation layer includes a rod-like liquid crystal compound, an angle between the azimuthal angle from one end of the optical axis (major axis) on the side opposite to the third optical compensation layer side toward one end of the optical axis on the third optical compensation layer side in the rod-like liquid crystal compound that is positioned on the surface of the liquid crystal layer of the first liquid crystal cell on the third optical compensation layer side and an azimuthal angle from one end of the optical axis on the first liquid crystal cell side toward one end of the optical axis on the side opposite to the first liquid crystal cell side in the rod-like liquid crystal compound of the third optical compensation layer is preferably 135° to 225°, more preferably 160° to 200°, and still more preferably 175° to 185°.

The fourth optical compensation layer 42 is a layer obtained by immobilizing a tilt-aligned disk-like liquid crystal compound as in the first optical compensation layer 12 and the second optical compensation layer 20.

As described above, even in a case where the liquid crystal layer 24 is applied with a voltage to enter an ON state, the rod-like liquid crystal compound LC10 shown in FIG. 10 that is provided in the liquid crystal layer 24 of the second liquid crystal cell 18 and positioned on the second polarizer 16 side is not likely to be tilt-aligned.

By providing the fourth optical compensation layer 42, light leak caused by the rod-like liquid crystal compound LC10 can be suppressed.

An angle between a projection axis where an optical axis of the disk-like liquid crystal compound in the fourth optical compensation layer 42 is projected onto a surface (main surface) of the fourth optical compensation layer 42 and an in-plane slow axis on a surface of the liquid crystal layer 24 of the second liquid crystal cell 18 on the fourth optical compensation layer 42 side is 0°. In addition, the surface of the fourth optical compensation layer 42 corresponds to one of two main surfaces orthogonal to the thickness direction of the fourth optical compensation layer 42. The above-described main surfaces refer to surfaces having the largest area in the fourth optical compensation layer 42.

The present invention is not limited to this aspect, and the angle formed by the projection axis obtained by projecting the optical axis of the liquid crystal compound in the fourth optical compensation layer onto the surface of the fourth optical compensation layer and the in-plane slow axis on the surface of the liquid crystal layer on the fourth optical compensation layer side in the second liquid crystal cell is preferably 0° to 5° and more preferably 0° to 2°. That is, the projection axis where the optical axis of the disk-like liquid crystal compound is projected onto the surface of the fourth optical compensation layer and the in-plane slow axis on the surface of the liquid crystal layer of the second liquid crystal cell on the fourth optical compensation layer side are preferably parallel to each other.

The angle between the disk plane of the disk-like liquid crystal compound in the fourth optical compensation layer 42 and the surface of the fourth optical compensation layer 42 is not particularly limited and is preferably 10° to 45° and more preferably 15° to 35°.

An angle between an azimuthal angle from one end of the optical axis (major axis) on the fourth optical compensation layer 42 side toward one end of the optical axis on the side opposite to the fourth optical compensation layer 42 side in the rod-like liquid crystal compound that is positioned on the surface of the liquid crystal layer 24 of the second liquid crystal cell 18 on the fourth optical compensation layer 42 side and an azimuthal angle from one end of the optical axis on the side opposite to the second liquid crystal cell 18 side toward one end of the optical axis on the second liquid crystal cell 18 side in the disk-like liquid crystal compound of the fourth optical compensation layer 42 is 0°. However, the present invention is not limited to this aspect, and the angle between the azimuthal angle from one end of the optical axis (major axis) on the fourth optical compensation layer side toward one end of the optical axis on the side opposite to the fourth optical compensation layer side in the rod-like liquid crystal compound that is positioned on the surface of the liquid crystal layer of the second liquid crystal cell on the fourth optical compensation layer side and the azimuthal angle from one end of the optical axis on the side opposite to the second liquid crystal cell side toward one end of the optical axis on the second liquid crystal cell side in the disk-like liquid crystal compound of the fourth optical compensation layer is preferably 0° to 45°, more preferably 0° to 20°, still more preferably 0° to 5°, and still more preferably 0° to 2°. That is, the azimuthal angle from one end of the optical axis (major axis) on the fourth optical compensation layer side toward one end of the optical axis on the side opposite to the fourth optical compensation layer side in the rod-like liquid crystal compound that is positioned on the surface of the liquid crystal layer of the second liquid crystal cell on the fourth optical compensation layer side and the azimuthal angle from one end of the optical axis on the side opposite to the second liquid crystal cell side toward one end of the optical axis on the second liquid crystal cell side in the disk-like liquid crystal compound of the fourth optical compensation layer are preferably parallel to each other.

In the above description, the aspect where the fourth optical compensation layer 42 includes the disk-like liquid crystal compound has been described. An aspect where the fourth optical compensation layer includes a rod-like liquid crystal compound may also be adopted. In a case where the fourth optical compensation layer includes a rod-like liquid crystal compound, the angle between the projection axis where the optical axis of the rod-like liquid crystal compound is projected onto the surface of the fourth optical compensation layer and the in-plane slow axis on the surface of the liquid crystal layer of the second liquid crystal cell on the fourth optical compensation layer side is preferably in the above-described range.

In a case where the fourth optical compensation layer includes a rod-like liquid crystal compound, an angle between the major axis of the rod-like liquid crystal compound and the surface of the fourth optical compensation layer is not particularly limited and is preferably 10° to 45° and more preferably 15° to 35°.

In a case where the fourth optical compensation layer includes a rod-like liquid crystal compound, the angle between the azimuthal angle from one end of the optical axis (major axis) on the fourth optical compensation layer side toward one end of the optical axis on the side opposite to the second optical compensation layer side in the rod-like liquid crystal compound that is positioned on the surface of the liquid crystal layer of the second liquid crystal cell on the fourth optical compensation layer side and the azimuthal angle from one end of the optical axis on the side opposite to the second liquid crystal cell side toward one end of the optical axis on the second liquid crystal cell side in the rod-like liquid crystal compound of the fourth optical compensation layer is preferably 135° to 225°, more preferably 160° to 200°, and still more preferably 175° to 185°.

Hereinafter, in the above-described embodiment, any of the first optical compensation layer to the fourth optical compensation layer is a layer obtained by immobilizing the tilt-aligned liquid crystal compound (the disk-like liquid crystal compound or the rod-like liquid crystal compound). However, the present invention is not limited to this aspect. For example, as described below, any of the first optical compensation layer to the fourth optical compensation layer may be a layer obtained by immobilizing a hybrid-aligned liquid crystal compound.

Hereinafter, the members in the viewing angle control system according to the embodiment of the present invention will be described in detail.

### <First Polarizer, Second Polarizer, and Third Polarizer>

Any of the first polarizer, the second polarizer, and the third polarizer may be a member having a function of converting natural light into specific linearly polarized light, and examples thereof include an absorptive polarizer.

The kind of the polarizer is not particularly limited, and a commonly used polarizer can be used. Examples of the polarizer include an iodine-based polarizer, a dye-based polarizer using a dichroic substance, and a polyene-based polarizer. The iodine-based polarizer and the dye-based polarizer are generally prepared by adsorbing iodine or a dichroic dye on a polyvinyl alcohol, followed by stretching.

A protective film may be disposed on one side or both sides of the polarizer.

A disposition relationship between the first polarizer, the second polarizer, and the third polarizer is as described above.

### <First Liquid Crystal Cell and Second Liquid Crystal Cell>

Both of the first liquid crystal cell and the second liquid crystal cell are TN-mode liquid crystal cells.

As described above, the TN-mode liquid crystal cell is a liquid crystal cell where the liquid crystal compound in the liquid crystal cell is twist-aligned. The TN-mode liquid crystal cell can rotate linearly polarized light incident into the liquid crystal cell by 80° to 100°.

The configuration of the first liquid crystal cell and the second liquid crystal cell is not particularly limited, and examples thereof include a well-known configuration of the TN-mode liquid crystal cell. As described above, the configuration includes two substrates and a liquid crystal layer disposed between the two substrates.

The kind of the liquid crystal compound in the liquid crystal layer is not particularly limited, and examples thereof include a well-known liquid crystal compound used in the TN-mode liquid crystal cell.

### <First Optical Compensation Layer to Fourth Optical Compensation Layer>

The first optical compensation layer to the fourth optical compensation layer (hereinafter, these layers will also be collectively simply referred to as “optical compensation layer”) are layers disposed between the respective members as described above.

The optical compensation layer (the first optical compensation layer to the fourth optical compensation layer) is a layer where, in a case where a retardation is measured from a normal direction of the optical compensation layer and a direction tilted from the normal direction, the retardation is at a minimum in the direction tilted from the normal direction.

That is, the first optical compensation layer is a layer where, in a case where a retardation is measured from a normal direction of the first optical compensation layer and a direction tilted from the normal direction, the retardation is at a minimum in the direction tilted from the normal direction. The retardation measured from the normal direction of the first optical compensation layer is an in-plane retardation orthogonal to the normal direction of the first optical compensation layer, and the retardation measured from the direction tilted from the normal direction of the first optical compensation layer is an in-plane retardation orthogonal to the direction tilted from the normal direction of the first optical compensation layer.

In addition, the second optical compensation layer is a layer where, in a case where a retardation is measured from a normal direction of the second optical compensation layer and a direction tilted from the normal direction, the retardation is at a minimum in the direction tilted from the normal direction. The retardation measured from the normal direction of the second optical compensation layer is an in-plane retardation orthogonal to the normal direction of the second optical compensation layer, and the retardation measured from the direction tilted from the normal direction of the second optical compensation layer is an in-plane retardation orthogonal to the direction tilted from the normal direction of the second optical compensation layer.

In addition, the third optical compensation layer is a layer where, in a case where a retardation is measured from a normal direction of the third optical compensation layer and a direction tilted from the normal direction, the retardation is at a minimum in the direction tilted from the normal direction. The retardation measured from the normal direction of the third optical compensation layer is an in-plane retardation orthogonal to the normal direction of the third optical compensation layer, and the retardation measured from the direction tilted from the normal direction of the third optical compensation layer is an in-plane retardation orthogonal to the direction tilted from the normal direction of the third optical compensation layer.

In addition, the fourth optical compensation layer is a layer where, in a case where a retardation is measured from a normal direction of the fourth optical compensation layer and a direction tilted from the normal direction, the retardation is at a minimum in the direction tilted from the normal direction. The retardation measured from the normal direction of the fourth optical compensation layer is an in-plane retardation orthogonal to the normal direction of the fourth optical compensation layer, and the retardation measured from the direction tilted from the normal direction of the fourth optical compensation layer is an in-plane retardation orthogonal to the direction tilted from the normal direction of the fourth optical compensation layer.

More specifically, the optical compensation layer (the first optical compensation layer to the fourth optical compensation layer) is a layer where, in a case where measurement 1 and measurement 2 below are performed, the retardation is at a minimum in the measurement 2.

Measurement 1: the retardation is measured from the normal direction of the optical compensation layer.

Measurement 2: the retardation is measured while changing a tilt angle in the direction tilted from the normal direction along the in-plane slow axis of the optical compensation layer or the direction orthogonal to the in-plane slow axis.

A method for performing the measurement 1 and the measurement 2 will be described below.

The above-described measurement is performed by actually measuring the Mueller matrix at a wavelength of 550 nm using AxoScan (manufactured by Axometrics, Inc.). Specifically, using the measurement mode of AxoScan “Two-Axis Out-of-Plane Retardance Measurement”, an in-plane slow axis direction and an in-plane fast axis direction of the optical compensation layer are initially detected, the Mueller matrix at a wavelength of 550 nm is actually measured while changing the measurement angle at an interval of 1° in a polar angle range of −75° to 75° in the detected in-plane slow axis direction and the detected in-plane fast axis direction, and a tilt alignment angle is calculated from a change in retardation. In a case where the angle at which the retardation is at a minimum is not 0°, the optical compensation layer that is a measurement object corresponds to the layer where the retardation is at a minimum in the direction tilted from the normal direction.

Examples of the layer having the above-described characteristics include the above-described layer obtained by immobilizing the tilt-aligned liquid crystal compound and a layer obtained by immobilizing a hybrid-aligned liquid crystal compound. With these layers, as described above, light leak caused by the liquid crystal compound in the first liquid crystal cell and the second liquid crystal cell can be suppressed.

The optical compensation layer does not need to be a layer that is formed using a liquid crystal compound as long as the above-described characteristics are exhibited, and examples thereof include a resin film.

As the optical compensation layer, a layer obtained by immobilizing a tilt-aligned or hybrid-aligned liquid crystal compound is preferable.

The tilt alignment refers to alignment where a tilt angle of the liquid crystal compound is fixed from one surface toward another surface. The tilt angle being fixed represents that a difference in tilt angle is within 10°.

The hybrid alignment refers to alignment where a tilt angle of the liquid crystal compound continuously changes from one surface toward another surface.

Examples of the liquid crystal compound include a rod-like liquid crystal compound and a disk-like liquid crystal compound.

As the rod-like liquid crystal compound, for example, those described in claim 1 of JP1999-513019A (JP-H11-513019A) or paragraphs [0026] to [0098] of JP2005-289980A are preferable; and as the disk-like liquid crystal compound, those described in paragraphs [0020] to [0067] of JP2007-108732A or paragraphs [0013] to [0108] of JP2010-244038A are preferable.

The liquid crystal compound preferably has a polymerizable group. That is, the liquid crystal compound is preferably a polymerizable liquid crystal compound. Examples of the polymerizable group included in the liquid crystal compound include a radically polymerizable group such as an acryloyl group, a methacryloyl group, and a vinyl group, and a cationically polymerizable group such as an epoxy group.

By polymerizing the polymerizable liquid crystal compound, the alignment of the liquid crystal compound can be immobilized. After immobilizing the liquid crystal compound by polymerization, it is no longer necessary to exhibit liquid crystallinity.

The optical compensation layer (the first optical compensation layer to the fourth optical compensation layer) is preferably a layer that is formed using a composition including a liquid crystal compound having a polymerizable group.

The in-plane retardation of the optical compensation layer (the first optical compensation layer to the fourth optical compensation layer) at a wavelength of 550 nm (the in-plane retardation at a wavelength of 550 nm measured from the normal direction of the optical compensation layer) is not particularly limited, and is preferably 15 to 120 nm and more preferably 15 to 65 nm.

A thickness of the optical compensation layer (the first optical compensation layer to the fourth optical compensation layer) is not particularly limited, and is preferably 0.3 to 2.0 μm and more preferably 0.5 to 1.5 μm.

Hereinafter, a method for manufacturing the optical compensation layer (the first optical compensation layer to the fourth optical compensation layer) using the composition including the liquid crystal compound having the polymerizable group will be described in detail.

The liquid crystal compound having the polymerizable group (hereinafter, also referred to as “polymerizable liquid crystal compound”) in the composition is as described above. As described above, the rod-like liquid crystal compound and the disk-like liquid crystal compound are appropriately selected depending on characteristics of an optically anisotropic layer to be formed.

A content of the polymerizable liquid crystal compound in the composition is preferably 60% to 99% by mass and more preferably 70% to 98% by mass with respect to the total solid content of the composition.

The solid content refers to a component capable of forming an optical compensation layer from which a solvent has been removed, and even in a case where a component itself is in a liquid state, such a component is regarded as the solid content.

The composition may include other components other than the liquid crystal compound having the polymerizable group.

The composition may include a polymerization initiator. The polymerization initiator to be used is selected depending on the type of the polymerization reaction, and examples thereof include a thermal polymerization initiator and a photopolymerization initiator.

The content of the polymerization initiator in the composition is preferably 0.01% to 20% by mass, and more preferably 0.5% to 10% by mass with respect to the total solid content of the composition.

Examples of other components that may be included in the composition include a polyfunctional monomer, an alignment control agent (a vertical alignment agent and a horizontal alignment agent), a surfactant, an adhesion improver, a plasticizer, and a solvent, in addition to the foregoing components.

Examples of a method for applying the composition include a curtain coating method, a dip coating method, a spin coating method, a printing coating method, a spray coating method, a slot coating method, a roll coating method, a slide coating method, a blade coating method, a gravure coating method, and a wire bar method.

Next, the formed coating film is subjected to an alignment treatment to align a polymerizable liquid crystal compound in the coating film. For example, in a case where the layer obtained by immobilizing the tilt-aligned liquid crystal compound is formed, the polymerizable liquid crystal compound is tilt-aligned. In addition, in a case where the layer obtained by immobilizing the hybrid-aligned liquid crystal compound is formed, the polymerizable liquid crystal compound is hybrid-aligned.

The alignment treatment can be performed by drying the coating film at room temperature or by heating the coating film. In the case of a thermotropic liquid crystal compound, the liquid crystal phase formed by the alignment treatment can generally be transferred by a change in temperature or pressure. In the case of a lyotropic liquid crystal compound, a liquid crystal phase formed by the alignment treatment can also be transferred by a compositional ratio such as the amount of a solvent.

In a case where the coating film is heated, conditions are not particularly limited, and the heating temperature is preferably 50° C. to 250° C. and more preferably 50° C. to 150° C., and the heating time is preferably 10 seconds to 10 minutes.

In addition, before performing a curing treatment (light irradiation treatment) after heating the coating film, optionally, the coating film may be cooled.

Next, the coating film in which the polymerizable liquid crystal compound is aligned is cured.

A method of curing the coating film in which the polymerizable liquid crystal compound is aligned is not particularly limited, and examples thereof include a light irradiation treatment and a heat treatment. Among these, from the viewpoint of manufacturing suitability, a light irradiation treatment is preferable, and an ultraviolet irradiation treatment is more preferable.

The irradiation condition of the light irradiation treatment is not particularly limited, and an irradiation amount of 50 to 1,000 mJ/cm² is preferable.

The atmosphere during the light irradiation treatment is not particularly limited and is preferably a nitrogen atmosphere.

### <Method for Manufacturing Viewing Angle Control System>

A method for manufacturing the viewing angle control system is not particularly limited, and examples thereof include a method of preparing various members described above and laminating the members through a bonding layer or the like.

### <Use>

The viewing angle control system according to the embodiment of the present invention is applicable to various uses.

For example, the viewing angle control system according to the embodiment of the present invention is applicable to an image display apparatus. More specifically, the image display apparatus according to the embodiment of the present invention comprises an image display element and the above-described viewing angle control system (the first embodiment to the second embodiment).

Examples of the image display element include a liquid crystal display element and an organic electroluminescence display element.

In a case where the viewing angle control system is disposed on the image display element, a laminating direction thereof is not particularly limited.

For example, in a case where the viewing angle control system according to the first aspect is disposed on the image display element, the viewing angle control system may be laminated on the image display element such that the first polarizer side is the image display element side, or the viewing angle control system may be laminated on the image display element such that the third polarizer side is the image display element side.

The image display apparatus according to the embodiment of the present invention may have a curved shape.

### EXAMPLES

Hereinafter, the characteristics of the present invention will be described in detail using examples. Materials, used amounts, ratios, treatment details, treatment procedures, and the like shown below can be appropriately changed within a range not departing from the scope of the present invention. In addition, configurations other than the configurations described below can also be adopted within a range not departing from the scope of the present invention.

### Example 1

A layer obtained by tilt-aligning a liquid crystal compound was prepared as follows.

### (Preparation of Transparent Support 1)

A surface of a cellulose acylate film 1 (TAC substrate with a thickness of 40 μm; TG40 manufactured by FUJIFILM Corporation) was saponified with an alkaline solution, and the following coating liquid 1 for forming an alignment layer was applied thereto using a wire bar. The support on which the coating film was formed was dried with hot air at 60° C. for 60 seconds and further dried with hot air at 100° C. for 120 seconds to form an alignment layer 1, thereby obtaining a TAC film with an alignment layer. The film thickness of the alignment layer was 0.5 μm.

In addition, the prepared TAC film with an alignment layer was used after rubbing the surface of the alignment film.

(Coating solution 1 for forming alignment layer)

| | | |
|---|---|---|
| Modified polyvinyl alcohol shown below | 3.80 | parts by mass |
| Initiator Irg2959 | 0.20 | parts by mass |
| Water | 70 | parts by mass |
| Methanol | 30 | parts by mass |

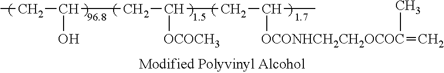

### (Preparation of Liquid Crystal Layer for Alignment)

A liquid crystal layer-forming composition T1 for alignment having the following composition was applied using a wire bar to the alignment film of the TAC film with the alignment layer to prepare a coating layer T1.

Next, the coating layer T1 was heated at 120° C. for 30 seconds, and the coating layer T1 was cooled to room temperature (23° C.). Next, the coating layer was further heated at 80° C. for 60 seconds and cooled to room temperature again.

Next, the coating layer was irradiated with light using a LED lamp (central wavelength: 365 nm) under an irradiation conditions of an illuminance of 200 mW/cm² for 1 second to prepare a liquid crystal layer T1 for alignment on the alignment layer 1. The film thickness of the liquid crystal layer T1 for alignment was 0.45 μm.

Composition of liquid crystal layer-
forming composition T1 for alignment

| | |
|---|---|
| Polymer liquid crystal compound | 55.20 parts by mass |
| P-1 shown below | |
| Low-molecular-weight liquid crystal | 40.49 parts by mass |
| compound M-1 shown below | |
| Polymerization initiator | 4.049 parts by mass |
| (IRGACURE OXE-02, manufactured by | |
| BASF SE) | |
| Surfactant F-1 shown below | 0.2620 parts by mass |
| Cyclopentanone | 660.6 parts by mass |
| Tetrahydrofuran | 660.6 parts by mass |

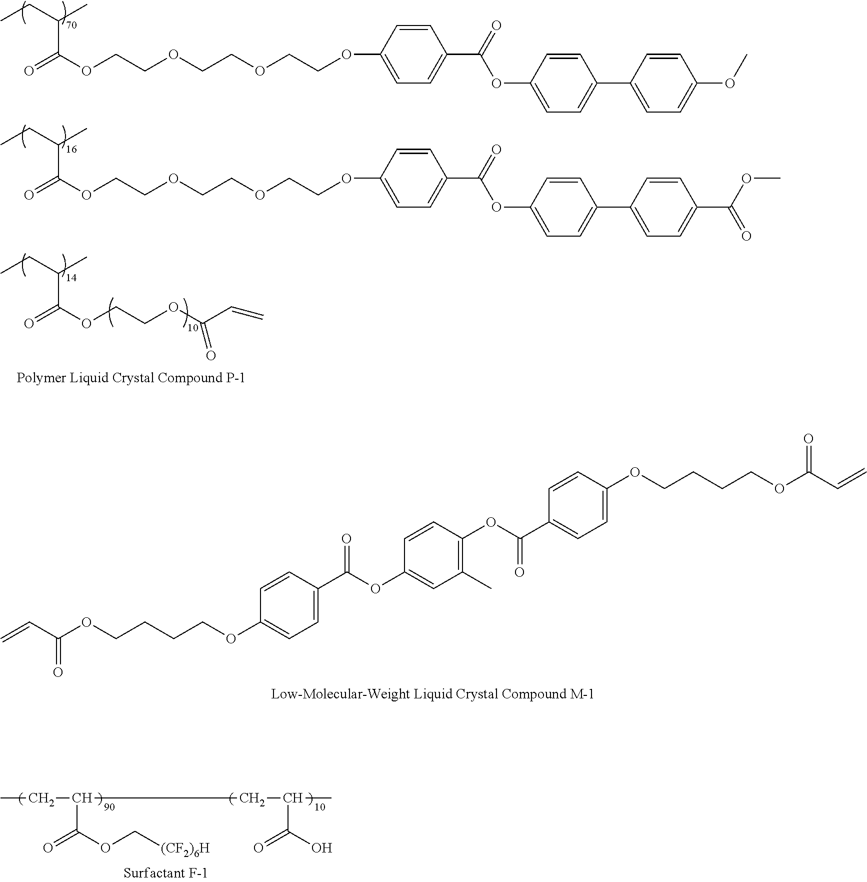

### (Formation of Tilt Alignment Layer A)

The following tilt alignment layer coating liquid A was applied to the obtained liquid crystal layer T1 for alignment using a wire bar to form a coating layer.

Next, the coating film was heated at 60° C. for 60 seconds. Next, the coating film was irradiated with UV at 60° C., and the alignment of the liquid crystal compound was immobilized to form a tilt alignment layer A. The film thickness of the tilt alignment layer A was 0.6 μm.

### (Measurement of Alignment Angle)

Regarding an optical film including the prepared tilt alignment layer A, an alignment angle was measured by actually measuring the Mueller matrix at a wavelength of 550 nm using AxoScan (manufactured by Axometrics, Inc.). Specifically, using the measurement mode of AxoScan “Two-Axis Out-of-Plane Retardance Measurement”, an in-plane slow axis direction and an in-plane fast axis direction were initially detected, the Mueller matrix at a wavelength of 550 nm was actually measured while changing the measurement angle at an interval of 1° in a polar angle range of −75° to 75° in the detected in-plane slow axis direction and the detected in-plane fast axis direction, and a tilt alignment angle was calculated from a change in retardation. It was found that the angle at which the retardation was the minimum was not 0° (normal direction).

Based on this measurement result, the in-plane retardation at a wavelength of 550 nm measured from the normal direction of the tilt alignment layer A was 20 nm, and the tilt angle (angle between the major axis of the rod-like liquid crystal compound and the surface of the tilt alignment layer A) was 30°.

Composition of Tilt Alignment Layer Coating Liquid A

| | |
|---|---|
| Rod-like liquid crystal compound-1 shown below | 6.61 parts by mass |
| Rod-like liquid crystal compound-2 shown below | 1.65 parts by mass |
| Photopolymerization initiator (IRGACURE 907, | 0.34 parts by mass |
| manufactured by BASF SE) | |
| Sensitizer (KAYACURE DETX, manufactured | 0.11 parts by mass |
| by Nippon Kayaku Co., Ltd.) | |
| Surfactant F-1 shown below | 0.01 parts by mass |
| Methyl ethyl ketone | 91.29 parts by mass |

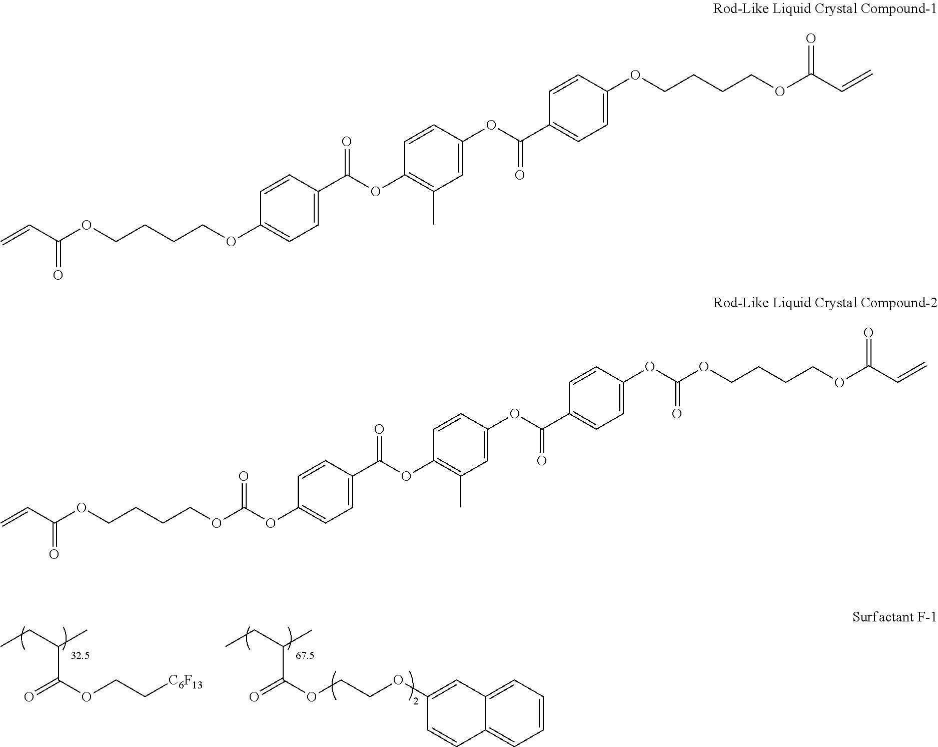

### (Preparation of Polarizing Plate)

A polarizing plate in which a thickness of a polarizer was 8 μm and one surface of the polarizer was exposed was prepared using the same method as that of a polarizing plate 02 with a one-surface protective film, described in WO2015/166991A.

### (Preparation of TN Liquid Crystal Cell for Viewing Angle Switching)

A horizontal alignment polyimide alignment film was applied to two glass substrates with ITO electrodes, was dried at a high temperature to form an alignment film, and was rubbed to form a TN cell. Specifically, an alignment treatment was performed so as to impart a 90° twist in the vertical direction.

Thereafter, a thermosetting sealing material was sprayed to one of the two substrates, and a bead spacer was sprayed to the other substrate, and the two substrates were bonded to each other, vacuum-packed, and heated to form an empty liquid crystal cell.

A liquid crystal with positive dielectric anisotropy, a refractivity anisotropy Δn of 0.0854 (589 nm, 20° C.), and Δε of +8.5 (MLC-9100, manufactured by Merck KGaA) was injected to the cell using a vacuum liquid crystal injector, and the cell was sealed to prepare a TN liquid crystal cell having a cell gap of 8 μm.

Further, since the inner surfaces of the upper and lower substrates were rubbed, the liquid crystal layer was twisted and aligned at a twisted angle of 90° between the upper and lower substrates in a case where a voltage was not applied, and a TN liquid crystal cell in which liquid crystals were aligned in an oblique direction by applying the voltage (2 V) was completed (refer to FIGS. 6 and 8).

### (Preparation of Viewing Angle Control System 1)

The prepared tilt alignment layer A, the prepared polarizing plate, and the prepared TN liquid crystal cell were bonded using a commercially available pressure sensitive adhesive (SK2057, manufactured by Soken Chemical & Engineering Co., Ltd.) to prepare a viewing angle control system 1 including the polarizing plate (polarizing plate-1)/the tilt alignment layer A (tilt alignment layer A-1)/the TN liquid crystal cell (TN liquid crystal cell-1)/the polarizing plate (polarizing plate-2)/the TN liquid crystal cell (TN liquid crystal cell-2)/the tilt alignment layer (tilt alignment layer A-2)/the polarizing plate (polarizing plate-3).

Hereinbelow, the members will also be referred to as the names in the parentheses.

In this case, the bonding was performed such that an absorption axis of the polarizing plate-1 and an absorption axis of the polarizing plate-3 had an azimuthal angle of 90° and an absorption axis of the polarizing plate-2 had an azimuthal angle of 0°. That is, the bonding was performed such that a transmission axis of the polarizing plate-1 and a transmission axis of the polarizing plate-3 had an azimuthal angle of 0° and a transmission axis of the polarizing plate-2 had an azimuthal angle of 90°.

In addition, the bonding was bonded such that an azimuthal angle at which an orientation of the optical axis of the liquid crystal compound in the tilt alignment layer A-1 (orientation from a tip of the optical axis on the polarizing plate-3 side to a tip of the optical axis on the polarizing plate-1 side) was projected onto the surface of the tilt alignment layer A-1 was 0°, and an azimuthal angle at which an orientation of the optical axis of the liquid crystal compound in the tilt alignment layer A-2 (orientation from a tip of the optical axis on the polarizing plate-3 side to a tip of the optical axis on the polarizing plate-1 side) was projected onto the surface of the tilt alignment layer A-2 was 0°.

In addition, an in-plane slow axis on the surface of the liquid crystal layer of the TN liquid crystal cell-1 on the tilt alignment layer A-1 side and a projection axis where the optical axis of the liquid crystal compound in the tilt alignment layer A-1 was projected onto the surface of the tilt alignment layer A-1 were parallel to each other. In addition, an in-plane slow axis on the surface of the liquid crystal layer of the TN liquid crystal cell-1 on the polarizing plate-2 side and the transmission axis of the polarizing plate-2 were parallel to each other.

An azimuthal angle at which an orientation of the optical axis of the liquid crystal compound positioned on the tilt alignment layer A-1 side of the liquid crystal layer in the TN liquid crystal cell-1 (orientation from a tip of the optical axis on the polarizing plate-3 side to a tip of the optical axis on the polarizing plate-1 side) was projected onto the surface of the polarizing plate-2 was 180°, and an azimuthal angle at which an orientation of the optical axis of the liquid crystal compound positioned on the polarizing plate-2 side of the liquid crystal layer in the TN liquid crystal cell-1 (orientation from a tip on the polarizing plate-3 side to a tip on the polarizing plate-1 side) was projected onto the surface of the polarizing plate-2 was 90°.

In addition, an in-plane slow axis on the surface of the liquid crystal layer of the TN liquid crystal cell-2 on the tilt alignment layer A-1 side and the projection axis where the optical axis of the liquid crystal compound in the tilt alignment layer A-1 was projected onto the surface of the tilt alignment layer A-1 were parallel to each other. In addition, the in-plane slow axis on the surface of the liquid crystal layer of the TN liquid crystal cell-1 on the polarizing plate-2 side and the transmission axis of the polarizing plate-2 were parallel to each other.
an azimuthal angle at which the orientation of the optical axis of the liquid crystal compound positioned on the polarizing plate-2 side of the liquid crystal layer in the TN liquid crystal cell-1 (orientation from a tip on the polarizing plate-3 side to a tip on the polarizing plate-1 side) was projected onto the surface of the polarizing plate-3 was 270°, and an azimuthal angle at which an orientation of the optical axis of the liquid crystal compound positioned on the polarizing plate-3 side of the liquid crystal layer in the TN liquid crystal cell-2 (orientation from a tip on the polarizing plate-3 side to a tip on the polarizing plate-1 side) was projected onto the surface of the polarizing plate-3 was 180°.

### (Preparation of Image Display Apparatus 1 Having Viewing Angle Switching Function)

The prepared viewing angle control system 1 was placed on a display screen of Dynabook (manufactured by Toshiba Corporation) as a laptop computer equipped with a liquid crystal display device to prepare an image display apparatus 1 having a viewing angle switching function. In this case, the viewing angle control system 1 was disposed such that the absorption axis of the polarizing plate on the viewing side of Dynabook and the absorption axis of the polarizing plate-3 of the viewing angle control system 1 were parallel to each other.

### Example 2

### (Preparation of Alignment Film 2)

The saponified cellulose acylate film 1 prepared in Example 1 was prepared. The following alignment film 2 coating liquid was prepared and was heated at 85° for 1 hour to dissolve the components while being stirred and was filtered through a 0.45 μm filter.

Alignment Film 2 Coating Liquid

| | |
|---|---|
| PVA 203 (manufactured by Kuraray Co., | 2.4 parts by mass |
| Ltd., polyvinyl alcohol) | |
| Pure water | 97.6 parts by mass |

The prepared alignment film 2 coating liquid was applied to the saponified cellulose acylate film 1 while adjusting the application amount such that the film thickness after drying was 0.5 μm, and the obtained coating film was dried at 100° C. for 2 minutes.

The dried coating film was rubbed to prepare a film-shaped temporary support. A rubbing direction was parallel to a longitudinal direction of the film.

### (Formation of Liquid Crystal Layer X1)

The following polymerizable liquid crystal composition X1 was stirred at room temperature to obtain a uniform solution. Next, the solution was filtered through a 0.45 μm filter.

Polymerizable Liquid Crystal Composition X1

| | | |
|---|---|---|
| Discotic liquid crystalline compound B-1 | 100 | parts by mass |
| shown below | | |
| Polymerizable monomer S1 shown below | 10 | parts by mass |
| Polymerization initiator (IRGACURE 907, | 3 | parts by mass |
| manufactured by BASF) | | |
| Methyl ethyl ketone | 339 | parts by mass |

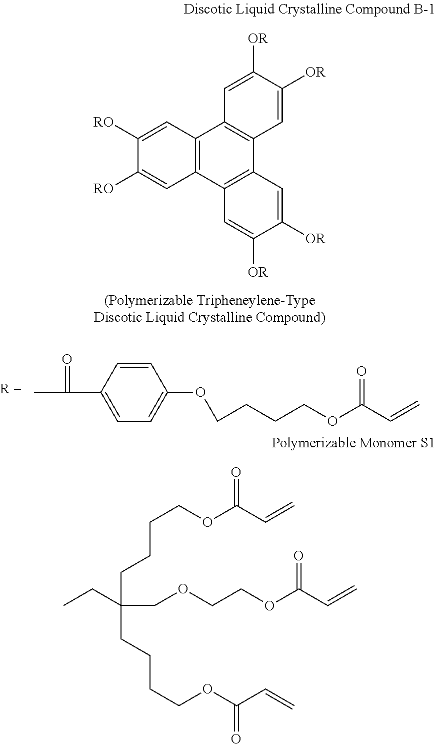

The prepared polymerizable liquid crystal composition X1 was applied to the rubbed surface of the temporary support while adjusting the application amount such that the film thickness after the drying and the ultraviolet exposure was 0.6 μm, and the coating film was dried. The obtained coating film was exposed to ultraviolet light, and the entire surface was subjected to photocuring and alignment immobilization to form a liquid crystal layer X1. In this case, drying conditions were 105° C. and 2 minutes, and ultraviolet exposure conditions were 80 mW/cm², 500 mJ/cm², and 80° C. In addition, during the ultraviolet exposure, nitrogen purging was performed, and the exposure was performed in an atmosphere where the oxygen concentration was 100 ppm.

### (Formation of Liquid Crystal Layer Y1)

The following polymerizable liquid crystal composition Y1 was prepared and stirred at room temperature to obtain a uniform solution. Next, the solution was filtered through a 0.45 μm filter.

Polymerizable Liquid Crystal Composition Y1

| | | |
|---|---|---|
| Discotic liquid crystalline compound A-1 | 80 | parts by mass |
| shown below | | |
| Discotic liquid crystalline compound A-2 | 20 | parts by mass |
| shown below | | |
| Polymerizable monomer S1 | 10 | parts by mass |
| Polymer C-1 shown below | 1.0 | part by mass |
| Polymerization initiator (IRGACURE 907, | 5 | parts by mass |
| manufactured by BASF) | | |
| Methyl ethyl ketone | 356 | parts by mass |

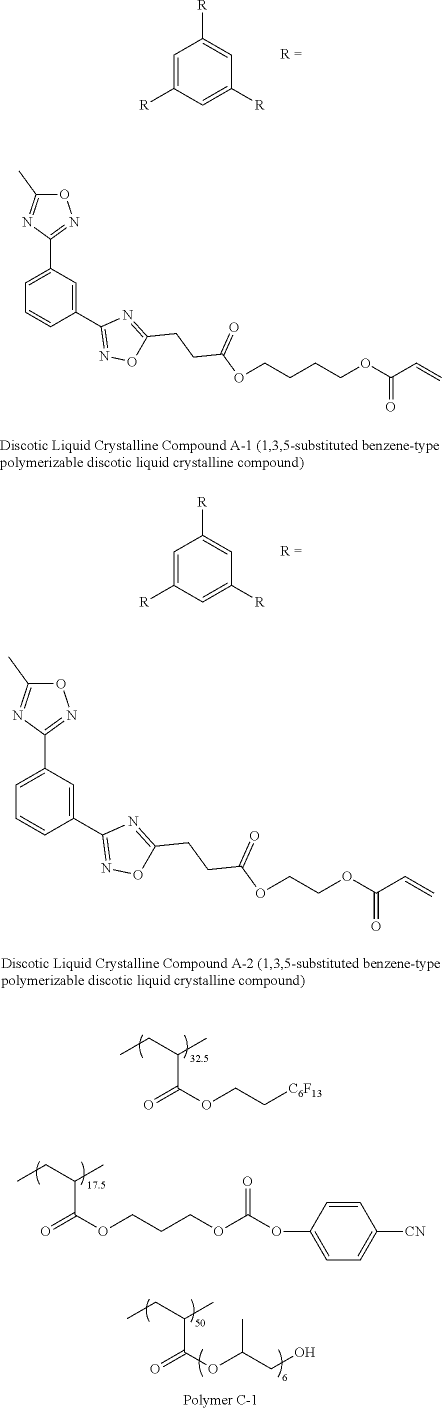

Numerical values described in the respective constitutional units represent % by mass of the respective constitutional units with respect to all the constitutional units of the polymer C-1, and are 32.5% by mass, 17.5% by mass, and 50.0% by mass in order from the left side, respectively.

The prepared polymerizable liquid crystal composition Y1 was applied to the prepared liquid crystal layer X1 while adjusting the application amount such that the film thickness after the drying and the ultraviolet exposure was 0.6 μm, and the coating film was dried. The obtained coating film was exposed to ultraviolet light, and the entire surface was subjected to photocuring and alignment immobilization to form a liquid crystal layer Y1. In this case, drying conditions were 120° C. and 2 minutes, and ultraviolet exposure conditions were 80 mW/cm², 500 mJ/cm², and 80° C. In addition, during the ultraviolet exposure, nitrogen purging was performed, and the exposure was performed in an atmosphere where the oxygen concentration was 100 ppm.

Through the above-described operation, a tilt alignment layer B including the liquid crystal layer X1 and the liquid crystal layer Y1 was prepared.

As a result of measuring an optical film including the prepared tilt alignment layer B with the above-described method, it was found that the angle at which the retardation was the minimum was not 0° (normal direction).

Based on this measurement result, the in-plane retardation at a wavelength of 550 nm measured from the normal direction of the tilt alignment layer B was 55 nm, and the tilt angle (angle between the major axis of the rod-like liquid crystal compound and the surface of the tilt alignment layer B) was 30°.

### (Preparation of Image Display Apparatus 2 Having Viewing Angle Switching Function)

An image display apparatus 2 having a viewing angle switching function was prepared using the same method as that of Example 1, except that the tilt alignment layer B (tilt alignment layer B-1, tilt alignment layer B-2) was used instead of the tilt alignment layer A, and the bonding was bonded such that an azimuthal angle at which an orientation of the optical axis of the liquid crystal compound in the tilt alignment layer B-1 (orientation from a tip of the optical axis on the polarizing plate-3 side to a tip of the optical axis on the polarizing plate-1 side) was projected onto the surface of the tilt alignment layer B-1 was 180°, and an azimuthal angle at which an orientation of the optical axis of the liquid crystal compound in the tilt alignment layer B-2 (orientation from a tip of the optical axis on the polarizing plate-3 side to a tip of the optical axis on the polarizing plate-1 side) was projected onto the surface of the tilt alignment layer B-2 was 180°.

### Example 3

### (Preparation of Transparent Support)

The following composition was put into a mixing tank, and the respective components were stirred under heating at 30° C. and dissolved to prepare a cellulose acylate solution. As the cellulose acylate solution, two kinds of dopes including a dope for an inner layer and a dope for an outer layer were prepared.

| | Inner | Outer |
|---|---|---|
| Cellulose acylate solution composition (parts by mass) | layer | Layer |
| Cellulose acetate having an acetylation | 100 | 100 |
| degree of 60.9% | | |
| Triphenyl phosphate (plasticizer) | 7.8 | 7.8 |
| Biphenyl diphenyl phosphate (plasticizer) | 3.9 | 3.9 |
| Methylene chloride (first solvent) | 293 | 314 |
| Methanol (second solvent) | 71 | 76 |
| 1-butanol (third solvent) | 1.5 | 1.6 |
| Silica particles (AEROSIL R972, manufactured | 0 | 0.8 |
| by Nippon Aerosil Co., Ltd.) | | |
| Retardation increasing agent shown below | 1.7 | 0 |

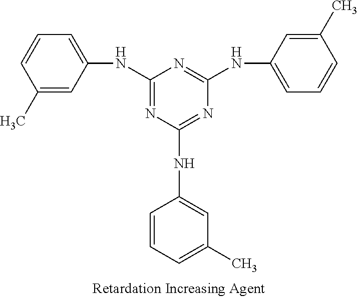 [SMILES: Cc1cccc(Nc2nc(Nc3cccc(C)c3)nc(Nc3cccc(C)c3)n2)c1]

The obtained dope for an inner layer and the obtained dope for an outer layer were cast onto drum cooled to 0° C. using a three-layer co-casting die. The film having a residual solvent amount of 70% by mass was peeled off from the drum, was dried at 80° C. while being transported at a draw ratio of 110% in a transport direction in a state where both ends were fixed to a pin tenter, and was dried at 110° C. in a case where the residual solvent amount was 10%. Next, the obtained film was dried at a temperature of 140° C. for 30 minutes to prepare a transparent support 1 of a cellulose acetate film (thickness: 80 μm (outer layer: 3 μm, inner layer: 74 μm, outer layer: 3 μm) having a residual solvent amount of 0.3% by mass. In the prepared cellulose acetate film, an in-plane retardation Re at a wavelength of 550 nm was 5 nm, and a thickness-direction retardation Rth at a wavelength of 550 nm was 90 nm.

The prepared cellulose acetate was dipped in a 2.0 N potassium hydroxide solution (25° C.) for 2 minutes, neutralized with sulfuric acid, cleaned with pure water, and dried.

### (Preparation of Alignment Film 3)

A coating liquid having the following composition was applied to the cellulose acetate film at 28 mL/m² using a #16 wire bar coater. The obtained coating film was dried with hot air at 60° C. for 60 seconds, and further dried with hot air at 90° C. for 150 seconds. The formed coating film surface was rubbed using a rubbing roll while being rotated at 500 turns/min in a direction parallel to a transport direction, thereby preparing an alignment film 3.

(Alignment Film 3 Coating Liquid Composition)

| | | |
|---|---|---|
| Modified polyvinyl alcohol below | 10 | parts by mass |
| Water | 370 | parts by mass |
| Methanol | 120 | parts by mass |
| Glutaraldehyde (crosslinking agent) | 0.5 | parts by mass |

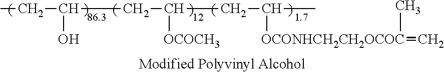

### (Preparation of Hybrid Alignment Layer)

The following coating liquid was continuously applied to the alignment film 3 surface of the film using a #3.2 wire bar. In a step of continuously heating the coating film from room temperature to 100° C., the solvent was dried and heated in a drying zone at 135° C. for about 90 seconds to align the discotic liquid crystal compound. Next, the film was transported to a drying zone at 80° C., and in a state where the surface temperature of the film was about 100° C., the film was irradiated with ultraviolet light at an illuminance of 600 mW for 10 seconds such that the crosslinking reaction progresses and the discotic liquid crystal compound was polymerized. Next, the film was allowed to cool to room temperature to prepare a hybrid alignment layer.

As a result of measuring an optical film including the prepared hybrid alignment layer with the above-described method, it was found that the angle at which the retardation was the minimum was not 0°.

Based on this measurement result, the in-plane retardation at a wavelength of 550 nm measured from the normal direction of the hybrid alignment layer was 30 nm, and the tilt angle (average tilt angle between the optical axis of the discotic liquid crystal compound and the surface of the hybrid alignment layer) was 15°.

(Hybrid Alignment Layer Coating Liquid Composition)

| | |
|---|---|
| Methyl ethyl ketone | 98 parts |
| | by mass |
| Discotic liquid crystal compound (1) shown below | 41.01 parts |
| | by mass |
| Ethylene oxide-modified trimethylolpropane triacrylate | 4.06 parts |
| (V#360, manufactured by Osaka Organic Chemical | by mass |
| Industry Ltd.) | |
| Cellulose acetate butyrate | 0.34 parts |
| (CAB551-0.2, manufactured by Eastman Chemical | by mass |
| Company) | |
| Cellulose acetate butyrate | 0.11 parts |
| (CAB531-1, manufactured by Eastman Chemical | by mass |
| Company) | |
| Fluoroaliphatic group-containing polymer 1 | 0.13 parts |
| | by mass |
| Fluoroaliphatic group-containing polymer 2 | 0.03 parts |
| | by mass |
| Photopolymerization initiator (IRGACURE 907, | 1.35 parts |
| manufactured by Ciba-Geigy AG) | by mass |
| Sensitizer (KAYACURE DETX, manufactured by | 0.45 parts |
| Nippon Kayaku Co., Ltd.) | by mass |

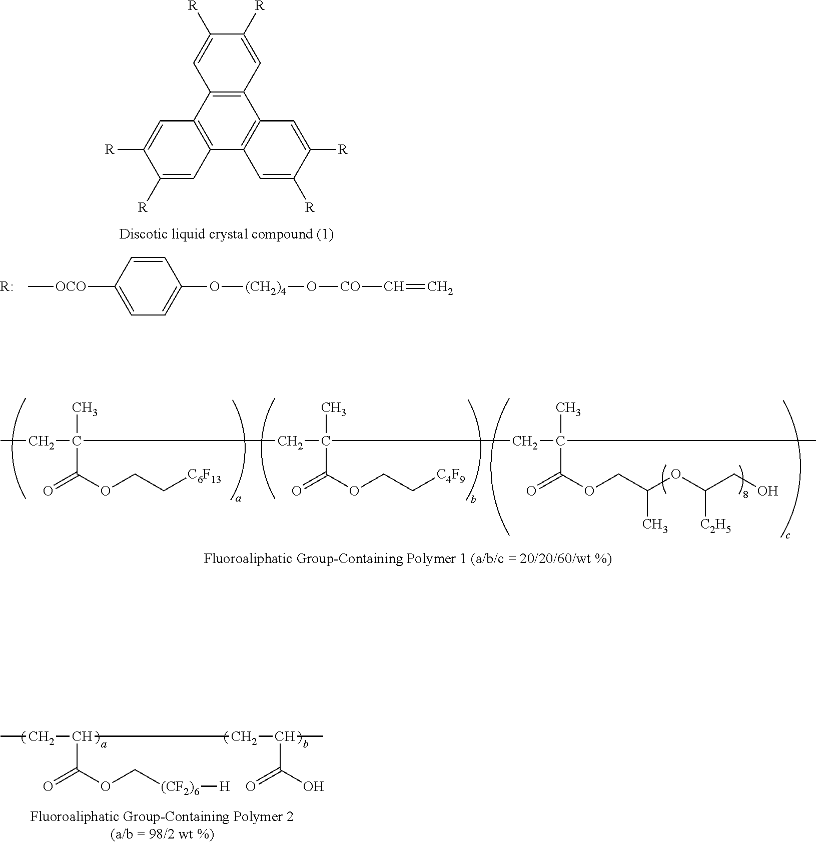

### (Preparation of Image Display Apparatus 3 Having Viewing Angle Switching Function)

An image display apparatus 3 having a viewing angle switching function was prepared using the same method as that of Example 1, except that the hybrid alignment layer (hybrid alignment layer-1, hybrid alignment layer-2) was used instead of the tilt alignment layer A, and the bonding was bonded such that an azimuthal angle at which an orientation of the optical axis of the liquid crystal compound in the hybrid alignment layer-1 (orientation from a tip of the optical axis on the polarizing plate-3 side to a tip of the optical axis on the polarizing plate-1 side) was projected onto the surface of the hybrid alignment layer-1 was 180°, and an azimuthal angle at which an orientation of the optical axis of the liquid crystal compound in the hybrid alignment layer-2 (orientation from a tip of the optical axis on the polarizing plate-3 side to a tip of the optical axis on the polarizing plate-1 side) was projected onto the surface of the hybrid alignment layer-2 was 180°.

### Example 4

### (Preparation of Viewing Angle Control System 4)

A viewing angle control system 4 having a configuration including the polarizing plate-1/the hybrid alignment layer-1/the TN liquid crystal cell-1/the polarizing plate-2/the TN liquid crystal cell-2/the hybrid alignment layer-2/the polarizing plate-3 was prepared using the same method as that of the preparation of the viewing angle control system 3 according to Example 3, except that the bonding was bonded such that an azimuthal angle at which an orientation of the optical axis of the liquid crystal compound in the hybrid alignment layer-1 (orientation from a tip of the optical axis on the polarizing plate-3 side to a tip of the optical axis on the polarizing plate-1 side) was projected onto the surface of the hybrid alignment layer-1 was 90°, and an azimuthal angle at which an orientation of the optical axis of the liquid crystal compound in the hybrid alignment layer-2 (orientation from a tip of the optical axis on the polarizing plate-3 side to a tip of the optical axis on the polarizing plate-1 side) was projected onto the surface of the hybrid alignment layer-2 was 270°.

### (Preparation of Image Display Apparatus 4 Having Viewing Angle Switching Function)

An image display apparatus 4 was prepared using the same method as that of the preparation of the image display apparatus 1 having a viewing angle switching function according to Example 1, except that the viewing angle control system 1 was changed to the viewing angle control system 4.

### Example 5

### (Preparation of Viewing Angle Control System 5)

The prepared hybrid alignment layer, the prepared polarizing plate, and the prepared TN liquid crystal cell were bonded to each other using a commercially available pressure sensitive adhesive (SK2057, manufactured by Soken Chemical & Engineering Co., Ltd.) to prepare a viewing angle control system 5 including the polarizing plate (polarizing plate-1)/the hybrid alignment layer (hybrid alignment layer-1)/the TN liquid crystal cell (TN liquid crystal cell-1)/the hybrid alignment layer (hybrid alignment layer-3)/the polarizing plate (polarizing plate-2)/the hybrid alignment layer (hybrid alignment layer-2)/the TN liquid crystal cell (TN liquid crystal cell-2)/the hybrid alignment layer (hybrid alignment layer-4)/the polarizing plate (polarizing plate-3).

Hereinbelow, the members will also be referred to as the names in the parentheses.

In this case, the bonding was performed such that an absorption axis of the polarizing plate-1 and an absorption axis of the polarizing plate-3 had an azimuthal angle of 90° and an absorption axis of the polarizing plate-2 had an azimuthal angle of 0°. That is, the bonding was performed such that a transmission axis of the polarizing plate-1 and a transmission axis of the polarizing plate-3 had an azimuthal angle of 0° and a transmission axis of the polarizing plate-2 had an azimuthal angle of 90°.

In addition, an azimuthal angle at which an orientation of the optical axis of the liquid crystal compound in the hybrid alignment layer-1 (orientation from a tip of the optical axis on the polarizing plate-3 side to a tip of the optical axis on the polarizing plate-1 side) was projected onto the surface of the hybrid alignment layer-1 was 90°, an azimuthal angle at which an orientation of the optical axis of the liquid crystal compound in the hybrid alignment layer-2 (orientation from a tip of the optical axis on the polarizing plate-3 side to a tip of the optical axis on the polarizing plate-1 side) was projected onto the surface of the hybrid alignment layer-2 was 270°, an azimuthal angle at which an orientation of the optical axis of the liquid crystal compound in the hybrid alignment layer-3 (orientation from a tip of the optical axis on the polarizing plate-3 side to a tip of the optical axis on the polarizing plate-1 side) was projected onto the surface of the hybrid alignment layer-3 was 90°, and an azimuthal angle at which an orientation of the optical axis of the liquid crystal compound in the hybrid alignment layer-4 (orientation from a tip of the optical axis on the polarizing plate-3 side to a tip of the optical axis on the polarizing plate-1 side) was projected onto the surface of the hybrid alignment layer-4 was 270°.

In addition, an azimuthal angle at which an orientation of the optical axis of the liquid crystal compound positioned on the hybrid alignment layer-1 side of the liquid crystal layer in the TN liquid crystal cell-1 (orientation from a tip on the polarizing plate-3 side to a tip on the polarizing plate-1 side) was projected onto the surface of the hybrid alignment layer-3 was 180°, and an azimuthal angle at which an orientation of the optical axis of the liquid crystal compound positioned on the hybrid alignment layer-3 side of the liquid crystal layer in the TN liquid crystal cell-1 (orientation from a tip on the polarizing plate-3 side to a tip on the polarizing plate-1 side) was projected onto the surface of the hybrid alignment layer-3 was 90°.

In addition, an azimuthal angle at which an orientation of the optical axis of the liquid crystal compound positioned on the hybrid alignment layer-4 side of the liquid crystal layer in the TN liquid crystal cell-2 (orientation from a tip on the polarizing plate-3 side to a tip on the polarizing plate-1 side) was projected onto the surface of the hybrid alignment layer-2 was 270°, and an azimuthal angle at which an orientation of the optical axis of the liquid crystal compound positioned on the hybrid alignment layer-2 side of the liquid crystal layer in the TN liquid crystal cell-2 (orientation from a tip on the polarizing plate-3 side to a tip on the polarizing plate-1 side) was projected onto the surface of the hybrid alignment layer-2 was 180°.

### (Preparation of Image Display Apparatus 5 Having Viewing Angle Switching Function)

An image display apparatus 5 was prepared using the same method as that of the preparation of the image display apparatus 1 having a viewing angle switching function according to Example 1, except that the viewing angle control system 1 was changed to the viewing angle control system 5.

### Comparative Example 1

### (Preparation of Viewing Angle Control System B1)

A viewing angle control system B1 including the polarizing plate (polarizing plate-1)/the TN liquid crystal cell (TN liquid crystal cell-1)/the polarizing plate (polarizing plate-2)/the TN liquid crystal cell (TN liquid crystal cell-2)/the polarizing plate (polarizing plate-3) was prepared using the same method as that of the preparation of the viewing angle control system 1 according to Example 1, except that the tilt alignment layer A was not bonded.

### (Preparation of Image Display Apparatus B1 Having Viewing Angle Switching Function)

An image display apparatus B1 was prepared using the same method as that of the preparation of the image display apparatus 1 having a viewing angle switching function according to Example 1, except that the viewing angle control system 1 was changed to the viewing angle control system B1.

### Comparative Example 2

### (Preparation of Negative A-Plate Layer (Non-Tilt Alignment Layer))

The above prepared alignment film 3 was continuously rubbed. Next, a negative A-plate layer coating liquid including a discotic liquid crystal compound having the following composition was continuously applied to the prepared alignment film 3 using a #5.0 wire bar to prepare a coating film. The transportation speed (V) of the film was 26 m/min. In order to dry the solvent of the coating liquid and to age the alignment of the discotic liquid crystal compound, the film was heated with hot air at 130° C. for 90 seconds, further heated with hot air at 100° C. for 60 seconds, and irradiated with UV light at 80° C. to immobilize the alignment of the liquid crystal compound, thereby preparing a negative A-plate layer. The thickness of the negative A-plate layer was 0.8 μm, and the in-plane retardation at a wavelength of 550 nm was 110 nm.

It was found that the average tilt angle with respect to the film surface of the disk plane of the discotic liquid crystal compound was 90°, and the discotic liquid crystal compound was vertically aligned with respect to the film surface.

Composition of Negative A-Plate Layer Coating Liquid

| | | |
|---|---|---|
| Discotic liquid crystal-1 shown below | 80 | parts by mass |
| Discotic liquid crystal-2 shown below | 20 | parts by mass |
| Alignment film interface alignment agent-1 | 0.55 | parts by mass |
| shown below | | |
| Alignment film interface alignment agent-2 | 0.05 | parts by mass |
| shown below | | |
| Surfactant F-4 shown below | 0.09 | parts by mass |
| Modified trimethylolpropane triacrylate | 10 | parts by mass |
| Photopolymerization initiator (IRGACURE 907, | 3.0 | parts by mass |
| manufactured by BASF SE) | | |
| Methyl ethyl ketone | 200 | parts by mass |

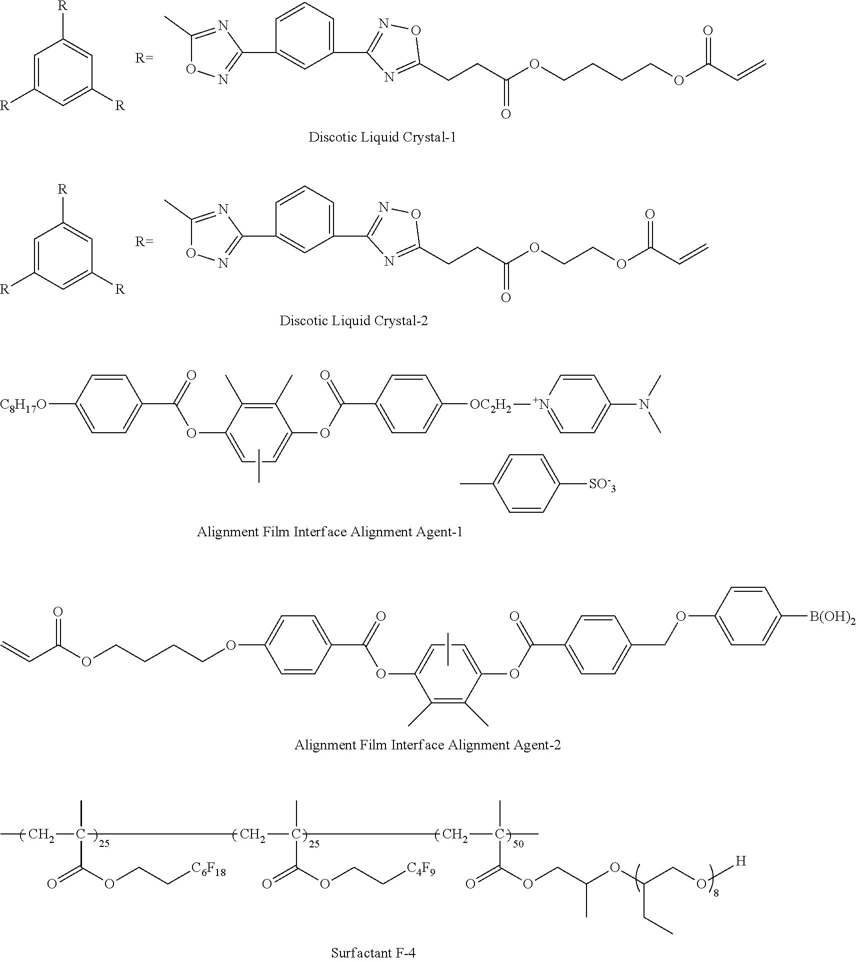

### (Preparation of Viewing Angle Control System B2)

A viewing angle control system B2 including the polarizing plate (polarizing plate-1)/the negative A-plate layer (negative A-plate layer-1)/the TN liquid crystal cell (TN liquid crystal cell-1)/the polarizing plate (polarizing plate-2)/the TN liquid crystal cell (TN liquid crystal cell-2)/the negative A-plate layer (negative A-plate layer-2)/the polarizing plate (polarizing plate-3) was prepared using the same method as that of the preparation of the viewing angle control system 1 according to Example 1, except that the tilt alignment layer A was changed to the negative A-plate layer. In this case, the bonding was performed such that the azimuthal angle of the optical axes of the negative A-plate layer-1 and the negative A-plate layer-2 was 0°.

### (Preparation of Image Display Apparatus B2 Having Viewing Angle Switching Function)

An image display apparatus B2 was prepared using the same method as that of the preparation of the image display apparatus 1 having a viewing angle switching function according to Example 1, except that the viewing angle control system 1 was changed to the viewing angle control system B2.

### <Evaluation of Viewing Angle Control System>

Regarding the prepared image display apparatus having a viewing angle switching function, the following evaluation was performed.

### (1) Light Leak in Oblique Direction

Regarding image recognition in a case where the image display apparatus was seen from the horizontal direction or an upper oblique direction in a mode (privacy mode) where the viewing angle was narrow, the evaluation was performed based on the following standards as compared to the image display apparatus B1 (Comparative Example 1). The results are shown in Table 1 below. C or higher is preferable.

### Evaluation Standards

A+: in a case where the image display apparatus was seen from the horizontal direction and the upper oblique direction, the display image was not able to be recognized.

A: in a case where the image display apparatus was seen from the horizontal direction, the display image was not able to be recognized.

B: in a case where the image display apparatus was seen from the horizontal direction, it was difficult to recognize the display image as compared to the image display apparatus B1.

C: in a case where the image display apparatus was seen from the horizontal direction, it was slightly difficult to recognize the display image as compared to the image display apparatus B1.

D: the display image was able to be recognized to the same degree as that of the image display apparatus B1.

### (2) Brightness in Front Direction

Regarding the brightness of the image display apparatus in a case where the image display apparatus was seen from the front direction in the mode (privacy mode) where the viewing angle was narrow, the evaluation was performed based on the following standards as compared to the image display apparatus B1 (Comparative Example 1).

### Evaluation Standards

A: A difference in brightness was not able to be recognized as compared to the image display apparatus B1.

B: the brightness was felt to be slightly darker as compared to the image display apparatus B1.

Numerical values in parentheses of the respective member fields of the field “Configuration” in Table 1 represent azimuthal angles.

In Table 1, the field “tilt angle” represents the angle (polar angle) from the normal direction where the retardation in the used optical compensation layer was the minimum.

In Table 1, the field “Angle” represents the angle between the projection axis where the optical axis of the disk-like liquid crystal compound is projected onto the surface of the first optical compensation layer and the in-plane slow axis on the surface of the liquid crystal layer of the first liquid crystal cell on the first optical compensation layer side, and the angle between the projection axis where the optical axis of the disk-like liquid crystal compound is projected onto the surface of the second optical compensation layer and the in-plane slow axis on the surface of the liquid crystal layer of the second liquid crystal cell on the second optical compensation layer side.

TABLE 1

| | | | | | | | Comparative | Comparative |
|---|---|---|---|---|---|---|---|---|
| | | Example 1 | Example 2 | Example 3 | Example 4 | Example 5 | Example 1 | Example 2 |
| | | Image Display | Image Display | Image Display | Image Display | Image Display | Image Display | Image Display |
| | | Apparatus 1 | Apparatus 2 | Apparatus 3 | Apparatus 4 | Apparatus 5 | Apparatus B1 | Apparatus B2 |
| Configuration | | Polarizing | Polarizing | Polarizing | Polarizing | Polarizing | Polarizing | Polarizing |
| | | Plate-1 | Plate-1 | Plate-1 | Plate-1 | Plate-1 | Plate-1 | Plate-1 |
| | | (90°) | (90°) | (90°) | (90°) | (90°) | (90°) | (90°) |
| | | Tilt | Tilt | Hybrid | Hybrid | Hybrid | (Upper | Negative |
| | | Alignment | Alignment | Alignment | Alignment | Alignment | Interface: | A-Plate-1 |
| | | Layer A-1 | Layer B-1 | Layer-1 | Layer-1 | Layer-1 | 180° | (Upper |
| | | (0°) | (180°) | (180°) | (90°) | (90°) | TN Cell-1 | Interface: |
| | | (Upper | (Upper | (Upper | (Upper | (Upper | (Lower | 180°) |
| | | Interface: | Interface: | Interface: | Interface: | Interface: | Interface: | TN Cell-1 |
| | | 180°) | 180°) | 180°) | 180°) | 180°) | 90°) | (Lower |
| | | TN Cell-1 | TN Cell-1 | TN Cell-1 | TN Cell-1 | TN Cell-1 | Polarizing | Interface: |
| | | (Lower | (Lower | (Lower | (Lower | (Lower | Plate-2 | 90°) |
| | | Interface: | Interface: | Interface: | Interface: | Interface: | (0°) | Polarizing |
| | | 90°) | 90°) | 90°) | 90°) | 90°) | (Upper | Plate-2 |
| | | Polarizing | Polarizing | Polarizing | Polarizing | Hybrid | Interface: | (0°) |
| | | Plate-2 | Plate-2 | Plate-2 | Plate-2 | Alignment | 270°) | (Upper |
| | | (0°) | (0°) | (0°) | (0°) | Layer-3 | TN Cell-2 | Interface: |
| | | (Upper | (Upper | (Upper | (Upper | (90°) | (Lower | 270°) |
| | | Interface: | Interface: | Interface: | Interface: | Polarizing | Interface: | TN Cell-2 |
| | | 270°) | 270°) | 270°) | 270°) | Plate-2 | 180°) | (Lower |
| | | TN Cell-2 | TN Cell-2 | TN Cell-2 | TN Cell-2 | (0°) | Polarizing | Interface: |
| | | (Lower | (Lower | (Lower | (Lower | Hybrid | Plate-3 | 180°) |
| | | Interface: | Interface: | Interface: | Interface: | Alignment | (90°) | Negative |
| | | 180°) | 180°) | 180°) | 180°) | Layer-2 | Laptop | A-Plate-2 |
| | | Tilt | Tilt | Hybrid | Hybrid | (270°) | PC | Polarizing |
| | | Alignment | Alignment | Alignment | Alignment | (Upper | | Plate-3 |
| | | Layer A-2 | Layer B-2 | Layer-2 | Layer-2 | Interface: | | (90°) |
| | | (0°) | (180°) | (180°) | (270°) | 270°) | | Laptop |
| | | Polarizing | Polarizing | Polarizing | Polarizing | TN Cell-2 | | PC |
| | | Plate-3 | Plate-3 | Plate-3 | Plate-3 | (Lower | | |
| | | (90°) | (90°) | (90°) | (90°) | Interface: | | |
| | | Laptop | Laptop | Laptop | Laptop | 180°) | | |
| | | PC | PC | PC | PC | Hybrid | | |
| | | | | | | Alignment | | |
| | | | | | | Layer-4 | | |
| | | | | | | (270°) | | |
| | | | | | | Polarizing | | |
| | | | | | | Plate-3 | | |
| | | | | | | (90°) | | |
| | | | | | | Laptop | | |
| | | | | | | PC | | |
| Number of Optical | | 2 | 2 | 2 | 2 | 4 | 0 | 2 |
| Compensation Layers | | | | | | | | |
| Tilt Angle | | 30° | 30° | 15° | 15° | 15° | — | 0° |
| Kind of | | Rod-Like | Disk-Like | Disk-Like | Disk-Like | Disk-Like | — | Disk-Like |
| Compensation Layer | | Liquid | Liquid | Liquid | Liquid | Liquid | | Liquid |
| | | Crystal | Crystal | Crystal | Crystal | Crystal | | Crystal |
| | | Tilt | Tilt | Hybrid | Hybrid | Hybrid | | Vertical |
| | | Alignment | Alignment | Alignment | Alignment | Alignment | | Alignment |
| Angle | | 0° | 0° | 0° | 90° | 90° | — | — |
| Evaluation | Brightness | A | A | A | A | A | — | B |
| | in Front | | | | | | | |
| | Direction | | | | | | | |
| | Light | C | B | B | A | A+ | — | D |
| | Leak in | | | | | | | |
| | Oblique | | | | | | | |
| | Direction | | | | | | | |

As shown in Table 1, it was found that the viewing angle control system according to the embodiment of the present invention exhibited the desired effects.

It was found from a comparison between Examples 1 and 2 that, by using the disk-like liquid crystal compound as the material of the optical compensation layer, the effect is further improved.

It was found from a comparison between Examples 3 and 4 that, in a case where the angle between the projection axis where the optical axis of the disk-like liquid crystal compound is projected onto the surface of the first optical compensation layer and the in-plane slow axis on the surface of the liquid crystal layer of the first liquid crystal cell on the first optical compensation layer side is 45° to 135° and the angle between the projection axis where the optical axis of the disk-like liquid crystal compound is projected onto the surface of the second optical compensation layer and the in-plane slow axis on the surface of the liquid crystal layer of the second liquid crystal cell on the second optical compensation layer side is 45° to 135°, the effect is further improved.

It was found from a comparison between Example 5 and other Examples that, in a case where the third optical compensation layer and the fourth optical compensation layer are used, the effect is further improved.

### EXPLANATION OF REFERENCES

10: first polarizer
12: first optical compensation layer
14: first liquid crystal cell
16: second polarizer
18: second liquid crystal cell
20, 20A: second optical compensation layer
22: third polarizer
24, 30: liquid crystal layer
26, 28, 32, 34: substrate
40: third optical compensation layer
42: fourth optical compensation layer

What is claimed is:

1. A viewing angle control system comprising, in the following order:
a first polarizer;
a first optical compensation layer;
a first liquid crystal cell;
a second polarizer;
a second liquid crystal cell;
a second optical compensation layer; and
a third polarizer,
wherein the first liquid crystal cell and the second liquid crystal cell are TN-mode liquid crystal cells,
the first optical compensation layer is a layer where, in a case where a retardation is measured from a normal direction of the first optical compensation layer and a direction tilted from the normal direction of the first optical compensation layer, the retardation is at a minimum in the direction tilted from the normal direction of the first optical compensation layer, and
the second optical compensation layer is a layer where, in a case where a retardation is measured from a normal direction of the second optical compensation layer and a direction tilted from the normal direction of the second optical compensation layer, the retardation is at a minimum in the direction tilted from the normal direction of the second optical compensation layer.

2. The viewing angle control system according to claim 1,
wherein the first optical compensation layer and the second optical compensation layer are layers obtained by immobilizing a tilt-aligned or hybrid-aligned liquid crystal compound.

3. The viewing angle control system according to claim 2,
wherein the liquid crystal compound is a disk-like liquid crystal compound or a rod-like liquid crystal compound.

4. The viewing angle control system according to claim 2,
wherein an angle between a projection axis where an optical axis of the liquid crystal compound in the first optical compensation layer is projected onto a surface of the first optical compensation layer and an in-plane slow axis on a surface of a liquid crystal layer in the first liquid crystal cell on the first optical compensation layer side is 45° to 135°, and
an angle between a projection axis where an optical axis of the liquid crystal compound in the second optical compensation layer is projected onto a surface of the second optical compensation layer and an in-plane slow axis on a surface of a liquid crystal layer in the second liquid crystal cell on the second optical compensation layer side is 45° to 135°.

5. The viewing angle control system according to claim 1, further comprising:
a third optical compensation layer that is provided between the first liquid crystal cell and the second polarizer; and
a fourth optical compensation layer that is provided between the second polarizer and the second liquid crystal cell,
wherein the third optical compensation layer is a layer where, in a case where a retardation is measured from a normal direction of the third optical compensation layer and a direction tilted from the normal direction of the third optical compensation layer, the retardation is at a minimum in the direction tilted from the normal direction of the third optical compensation layer, and
the fourth optical compensation layer is a layer where, in a case where a retardation is measured from a normal direction of the fourth optical compensation layer and a direction tilted from the normal direction of the fourth optical compensation layer, the retardation is at a minimum in the direction tilted from the normal direction of the fourth optical compensation layer.

6. An image display apparatus comprising:
an image display element; and
the viewing angle control system according to claim 1.

7. The viewing angle control system according to claim 3,
wherein an angle between a projection axis where an optical axis of the liquid crystal compound in the first optical compensation layer is projected onto a surface of the first optical compensation layer and an in-plane slow axis on a surface of a liquid crystal layer in the first liquid crystal cell on the first optical compensation layer side is 45° to 135°, and
an angle between a projection axis where an optical axis of the liquid crystal compound in the second optical compensation layer is projected onto a surface of the second optical compensation layer and an in-plane slow axis on a surface of a liquid crystal layer in the second liquid crystal cell on the second optical compensation layer side is 45° to 135°.

8. The viewing angle control system according to claim 2, further comprising:
a third optical compensation layer that is provided between the first liquid crystal cell and the second polarizer; and
a fourth optical compensation layer that is provided between the second polarizer and the second liquid crystal cell,
wherein the third optical compensation layer is a layer where, in a case where a retardation is measured from a normal direction of the third optical compensation layer and a direction tilted from the normal direction of the third optical compensation layer, the retardation is at a minimum in the direction tilted from the normal direction of the third optical compensation layer, and
the fourth optical compensation layer is a layer where, in a case where a retardation is measured from a normal direction of the fourth optical compensation layer and a direction tilted from the normal direction of the fourth optical compensation layer, the retardation is at a minimum in the direction tilted from the normal direction of the fourth optical compensation layer.

9. An image display apparatus comprising:
an image display element; and
the viewing angle control system according to claim 2.

10. The viewing angle control system according to claim 3, further comprising:
a third optical compensation layer that is provided between the first liquid crystal cell and the second polarizer; and
a fourth optical compensation layer that is provided between the second polarizer and the second liquid crystal cell,
wherein the third optical compensation layer is a layer where, in a case where a retardation is measured from a normal direction of the third optical compensation layer and a direction tilted from the normal direction of the third optical compensation layer, the retardation is at a minimum in the direction tilted from the normal direction of the third optical compensation layer, and
the fourth optical compensation layer is a layer where, in a case where a retardation is measured from a normal direction of the fourth optical compensation layer and a direction tilted from the normal direction of the fourth optical compensation layer, the retardation is at a minimum in the direction tilted from the normal direction of the fourth optical compensation layer.

11. An image display apparatus comprising:
an image display element; and
the viewing angle control system according to claim 3.

12. The viewing angle control system according to claim 4, further comprising:
a third optical compensation layer that is provided between the first liquid crystal cell and the second polarizer; and
a fourth optical compensation layer that is provided between the second polarizer and the second liquid crystal cell,
wherein the third optical compensation layer is a layer where, in a case where a retardation is measured from a normal direction of the third optical compensation layer and a direction tilted from the normal direction of the third optical compensation layer, the retardation is at a minimum in the direction tilted from the normal direction of the third optical compensation layer, and
the fourth optical compensation layer is a layer where, in a case where a retardation is measured from a normal direction of the fourth optical compensation layer and a direction tilted from the normal direction of the fourth optical compensation layer, the retardation is at a minimum in the direction tilted from the normal direction of the fourth optical compensation layer.

13. An image display apparatus comprising:
an image display element; and
the viewing angle control system according to claim 4.

14. An image display apparatus comprising:
an image display element; and
the viewing angle control system according to claim 5.
